(19) United States
(12) Patent Application Publication
(10) Pub. No.: US 2026/0312661 A1
(43) Pub. Date: Oct. 8, 2026

(54) TRANSMITTING A CAPABILITY REPORT INDICATING A BEAM PREDICTION CAPABILITY OF A USER EQUIPMENT

(71) Applicant: QUALCOMM Incorporated, San Diego, CA (US)

(72) Inventors: Qiaoyu LI, Beijing (CN); Tao LUO, San Diego, CA (US); Mahmoud TAHERZADEH BOROUJENI, San Diego, CA (US)

(21) Appl. No.: 19/100,793

(22) PCT Filed: Sep. 29, 2022
(86) PCT No.: PCT/CN2022/122504

§ 371 Date: Feb. 3, 2025

(51) Int. Cl. H04B 7/06; H04W 24/10

(52) U.S. Cl. CPC H04B 7/06952; H04W 24/10

(57) ABSTRACT

Various aspects of the present disclosure generally relate to wireless communication. In some aspects, a user equipment (UE) may transmit a capability report associated with a beam prediction capability of the UE, the capability report indicating a target beam prediction accuracy. The UE may receive a request to perform a beam prediction task aligned with the capability report. The UE may transmit, based at least in part on the request, a beam prediction result satisfying the target beam prediction accuracy indicated in the capability report. Numerous other aspects are described.

### INTRODUCTION

Aspects of the present disclosure generally relate to wireless communication and to techniques and apparatuses for capability reporting.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory and one or more processors coupled to the memory. The one or more processors may be configured to transmit a capability report associated with a beam prediction capability of the UE, the capability report indicating a target beam prediction accuracy. The one or more processors may be configured to receive a request to perform a beam prediction task aligned with the capability report. The one or more processors may be configured to transmit, based at least in part on the request, a beam prediction result satisfying the target beam prediction accuracy indicated in the capability report.

In some implementations, an apparatus for wireless communication at a network node includes a memory and one or more processors coupled to the memory. The one or more processors may be configured to receive a capability report associated with a beam prediction capability of the UE, the capability report indicating a target beam prediction accuracy. The one or more processors may be configured to transmit a request to perform a beam prediction task aligned with the capability report. The one or more processors may be configured to receive, based at least in part on the request, a beam prediction result satisfying the target beam prediction accuracy indicated in the capability report.

In some implementations, a method of wireless communication performed at an apparatus of a UE includes transmitting a capability report associated with a beam prediction capability of the UE, the capability report indicating a target beam prediction accuracy. The method includes receiving a request to perform a beam prediction task aligned with the capability report. The method includes transmitting, based at least in part on the request, a beam prediction result satisfying the target beam prediction accuracy indicated in the capability report.

In some implementations, a method of wireless communication performed at an apparatus of a network node includes receiving a capability report associated with a beam prediction capability of the UE, the capability report indicating a target beam prediction accuracy. The method includes transmitting a request to perform a beam prediction task aligned with the capability report. The method includes receiving, based at least in part on the request, a beam prediction result satisfying the target beam prediction accuracy indicated in the capability report.

In some implementations, a non-transitory computer-readable medium storing a set of instructions for wireless communication includes one or more instructions that, when executed by one or more processors of a UE, cause the UE to: transmit a capability report associated with a beam prediction capability of the UE, the capability report indicating a target beam prediction accuracy. The one or more instructions, when executed by one or more processors of the UE, cause the UE to receive a request to perform a beam prediction task aligned with the capability report. The one or more instructions, when executed by one or more processors of a UE, cause the UE to transmit, based at least in part on the request, a beam prediction result satisfying the target beam prediction accuracy indicated in the capability report.

In some implementations, a non-transitory computer-readable medium storing a set of instructions for wireless communication includes one or more instructions that, when executed by one or more processors of a network node, cause the network node to receive a capability report associated with a beam prediction capability of the UE, the capability report indicating a target beam prediction accuracy. The one or more instructions, when executed by one or more processors of the network node, cause the network node to transmit a request to perform a beam prediction task aligned with the capability report. The one or more instructions, when executed by one or more processors of the network node, cause the network node to receive, based at least in part on the request, a beam prediction result satisfying the target beam prediction accuracy indicated in the capability report.

In some implementations, an apparatus for wireless communication includes means for transmitting a capability report associated with a beam prediction capability of the apparatus, the capability report indicating a target beam prediction accuracy. The apparatus includes means for receiving a request to perform a beam prediction task aligned with the capability report. The apparatus includes means for transmitting, based at least in part on the request, a beam prediction result satisfying the target beam prediction accuracy indicated in the capability report.

In some implementations, an apparatus for wireless communication includes means for receiving a capability report associated with a beam prediction capability of the UE, the capability report indicating a target beam prediction accuracy. The apparatus includes means for transmitting a request to perform a beam prediction task aligned with the capability report. The apparatus includes means for receiving, based at least in part on the request, a beam prediction result satisfying the target beam prediction accuracy indicated in the capability report.

Aspects generally include a method, apparatus, system, computer program product, non-transitory computer-readable medium, user equipment, base station, network entity, network node, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of beam management, in accordance with the present disclosure.

FIG. 5 is a diagram illustrating an example of an artificial intelligence/machine learning (AI/ML)-based predictive beam management, in accordance with the present disclosure.

FIG. 6 is a diagram illustrating an example of an AI/ML model complexity, in accordance with the present disclosure.

FIGS. 7, 8A, 8B, 9A, 9B, 9C, and 10 are diagrams illustrating examples associated with transmitting a capability report indicating a beam prediction capability of a UE, in accordance with the present disclosure.

FIGS. 11-12 are diagrams illustrating example processes associated with transmitting a capability report indicating a beam prediction capability of a UE, in accordance with the present disclosure.

FIG. 13 is a diagram of an example apparatus for wireless communication, in accordance with the present disclosure.

FIG. 14 is a diagram illustrating an example of a hardware implementation for an apparatus employing a processing system, in accordance with the present disclosure.

FIG. 15 is a diagram illustrating an example implementation of code and circuitry for an apparatus, in accordance with the present disclosure.

FIG. 16 is a diagram of an example apparatus for wireless communication, in accordance with the present disclosure.

FIG. 17 is a diagram illustrating an example of a hardware implementation for an apparatus employing a processing system, in accordance with the present disclosure.

FIG. 18 is a diagram illustrating an example implementation of code and circuitry for an apparatus, in accordance with the present disclosure.

### DETAILED DESCRIPTION

A network node may schedule a user equipment (UE) to perform a beam prediction task. The beam prediction task may involve predicting best serving beams based on past beam measurements from beam measurement results, which may reduce signaling associated with measurement reporting. The serving beams that may be predicted using the beam prediction task may be associated with receive (Rx) beams at the UE, transmit (Tx) beams at the UE, Rx beams at the network node, and/or Tx beams at the network node. The UE may have a certain capability in terms of beam prediction, and the capability may vary between UEs. For example, the UE may share hardware used for beam prediction with other tasks, and when another task is running, the UE may have less hardware resources allocated for beam prediction.

The network node may be unaware of a complexity level of artificial intelligence (AI)/machine learning (ML) models that are able to be run by the UE when scheduling the UE to perform the beam prediction task. The network node may unknowingly schedule the UE to perform a beam prediction task that is not compatible with the capability of the UE. The UE may attempt to perform the beam prediction task based at least in part on the scheduling by the network node, but the UE may suffer from various complications. For example, the UE may become overloaded when attempting to perform the beam prediction task, which may cause the UE to malfunction or prompt the UE to restart. The UE may attempt to perform the beam prediction task when another high priority application is running, and the UE may not have sufficient hardware resources at the time to perform the beam prediction task. The UE may perform the beam prediction task but a limited capability of the UE may result in a relatively high probability of beam prediction inaccuracy.

In some aspects, the UE may indicate a capability report to the network node, which may assist the network node when scheduling the beam prediction task for the UE. The capability report may indicate various capabilities of the UE in terms of beam prediction. The capability report may indicate a target beam prediction accuracy (e.g., a required beam prediction accuracy or a beam prediction accuracy threshold). According to one or more examples, the capability report may indicate a level of beam prediction accuracy supported by the UE. The capability report may indicate types of reference signal resources which may be used as measurement resources for beam prediction. According to one or more examples, the UE may indicate the types of reference signal resources which may be configured or indicated by the network node as the measurement resources for beam prediction. The capability report may indicate types of reference signal resources and/or beams which may be used as beam prediction targets for beam prediction. For example, the UE may indicate the types of beams which may be predicted and/or reported by the UE.

In some aspects, the network node may receive the capability report from the UE. The network node may determine a beam prediction task to be performed by the UE, where the beam prediction task may depend on the capability of the UE. The network node may ensure that the beam prediction task is aligned with the capability report. According to one or more examples, the network node may refrain from assigning the UE with a beam prediction task that the UE does not have the capability perform. The UE may receive, from the network node, a request to perform the beam prediction task, which may be aligned with the capability report. The beam prediction task, when aligned with the capability report, may correspond to a beam prediction task that the UE is able to perform given a capability of the UE. On the other hand, when the beam prediction task is not aligned with the capability report, the UE may not be able to perform the beam prediction task given the capability of the UE. The UE may perform the beam prediction task and generate a beam prediction result. The beam prediction result may satisfy the target beam prediction accuracy indicated in the capability report. The UE may transmit, to the network node, the beam prediction result.

In some aspects, since the network node may assign the beam prediction task to the UE based at least in part on the UE's capability, the UE may be able to perform the beam prediction task without malfunctioning, thereby improving a performance of the UE. The UE may be scheduled with beam prediction tasks that the UE has the capability to perform, and the UE may not be scheduled with beam prediction tasks that the UE does not have the capability to perform. The UE may use hardware resources to perform the beam prediction tasks that are available for beam prediction, and the UE may not attempt to use hardware resources that are associated with high priority applications (e.g., applications with a higher priority as compared to the beam prediction task). For example, the UE may avoid or refrain from using hardware resources that are associated with the high priority applications. Further, an accuracy associated with the beam prediction result may be improved because the UE may be tasked with performing a beam prediction task that the UE has the capability to perform. The network node may use the information indicated by the UE when assigning the beam prediction task to the UE. Otherwise, when the network node does not have the information indicated by the UE, the UE may be tasked with performing a beam prediction task for which the UE is unable to accurately perform, thereby degrading a performance of the UE.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

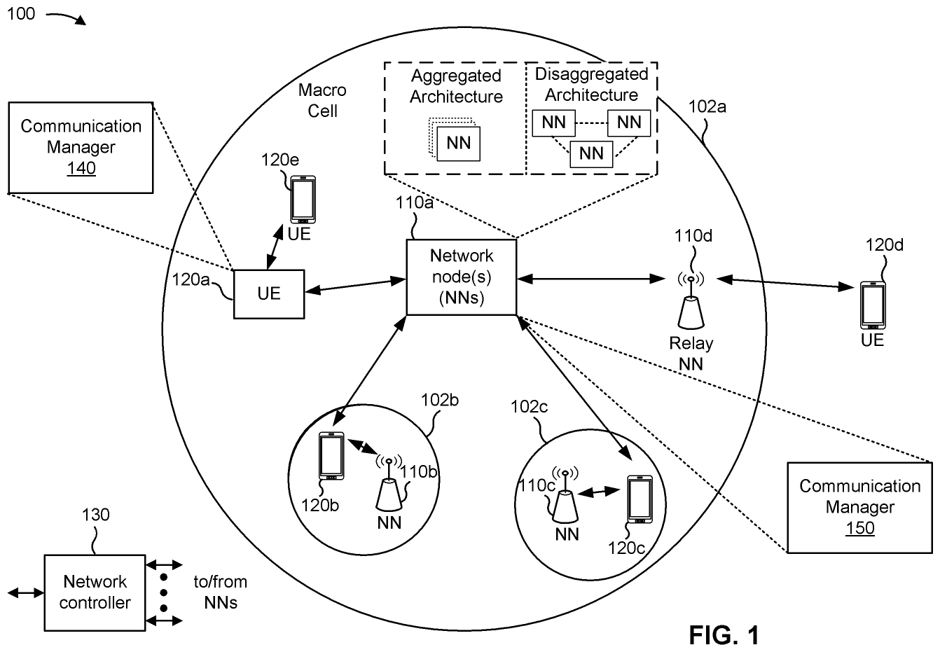

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IOT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In one example, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

The electromagnetic spectrum is often subdivided, by frequency/wavelength, into various classes, bands, channels, etc. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR 1 —is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may transmit a capability report associated with a beam prediction capability of the UE, the capability report indicating a target beam prediction accuracy; receive a request to perform a beam prediction task aligned with the capability report; and transmit, based at least in part on the request, a beam prediction result satisfying the target beam prediction accuracy indicated in the capability report. Additionally, or alternatively, the communication manager 140 may perform one or more other operations described herein.

In some aspects, a network node (e.g., network node 110) may include a communication manager 150. As described in more detail elsewhere herein, the communication manager 150 may receive a capability report associated with a beam prediction capability of the UE, the capability report indicating a target beam prediction accuracy, transmit a request to perform a beam prediction task aligned with the capability report, and receive, based at least in part on the request, a beam prediction result satisfying the target beam prediction accuracy indicated in the capability report. Additionally, or alternatively, the communication manager 150 may perform one or more other operations described herein.

As indicated above, FIG. 1 is provided as an example. Other examples may differ from what is described with regard to FIG. 1.

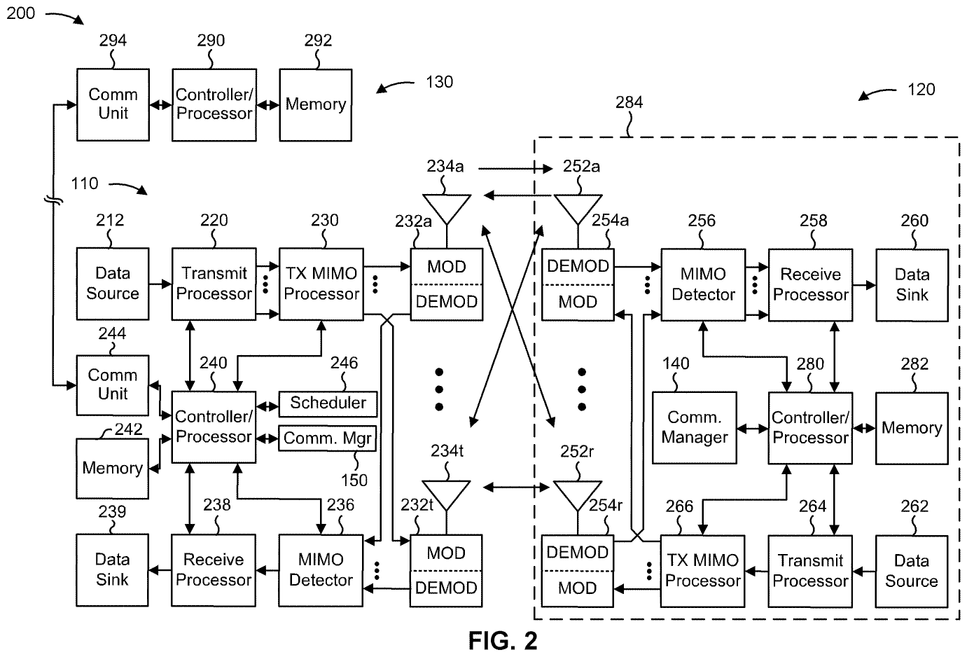

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A Tx multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., 7′output symbol streams) to a corresponding set of modems 232 (e.g., 1′ modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a Tx MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the Tx MIMO processor 266. The transceiver may be used by a processor (e.g., the controller/processor 280) and the memory 282 to perform aspects of any of the methods described herein.

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the Tx MIMO processor 230. The transceiver may be used by a processor (e.g., the controller/processor 240) and the memory 242 to perform aspects of any of the methods described herein.

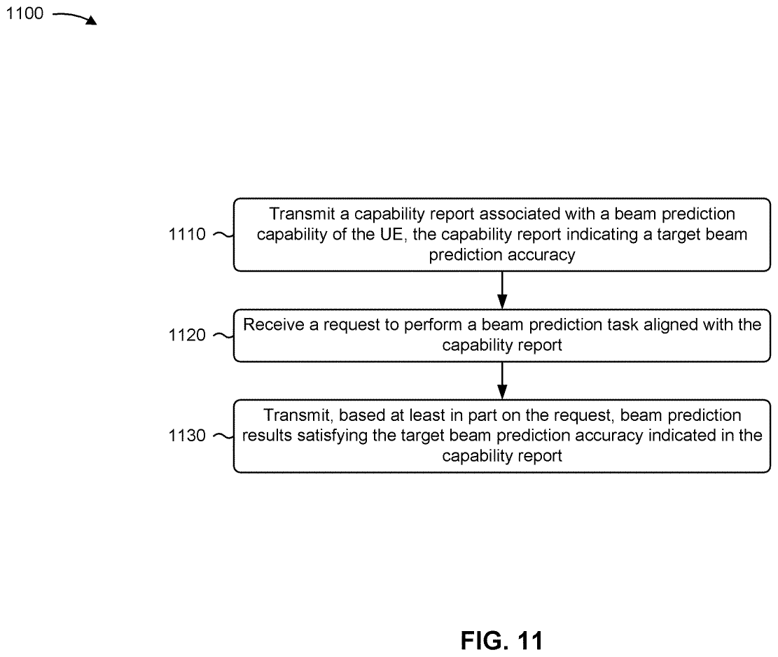

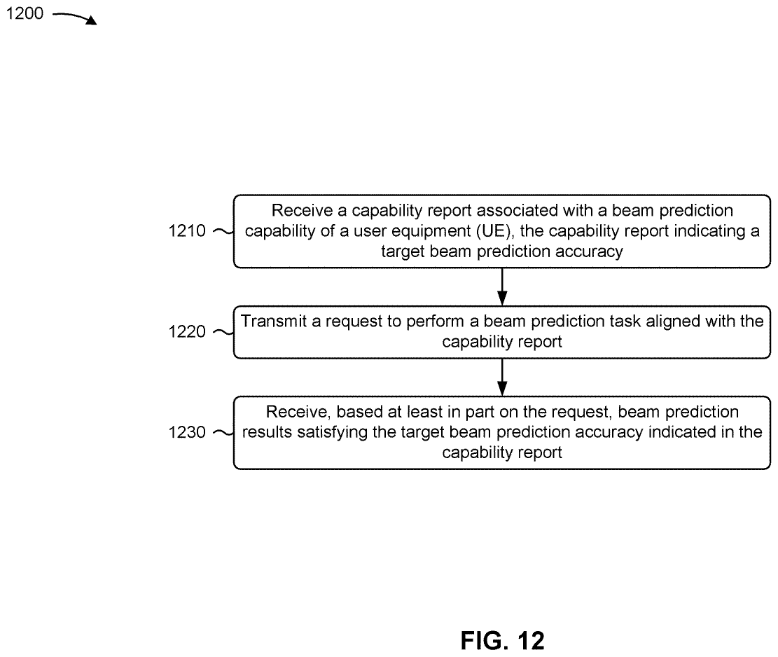

The controller/processor 240 of the network node 110, the controller/processor 280 of the UE 120, and/or any other component(s) of FIG. 2 may perform one or more techniques associated with transmitting a capability report indicating a beam prediction capability of a UE, as described in more detail elsewhere herein. For example, the controller/processor 240 of the network node 110, the controller/processor 280 of the UE 120, and/or any other component(s) of FIG. 2 may perform or direct operations of, for example, process 1100 of FIG. 11, process 1200 of FIG. 12, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, a UE (e.g., UE 120) includes means for transmitting a capability report associated with a beam prediction capability of the UE, the capability report indicating a target beam prediction accuracy; means for receiving a request to perform a beam prediction task aligned with the capability report; and/or means for transmitting, based at least in part on the request, a beam prediction result satisfying the target beam prediction accuracy indicated in the capability report. The means for the UE to perform operations described herein may include, for example, one or more of communication manager 140, antenna 252, modem 254, MIMO detector 256, receive processor 258, transmit processor 264, Tx MIMO processor 266, controller/processor 280, or memory 282.

In some aspects, a network node (e.g., network node 110) includes means for receiving a capability report associated with a beam prediction capability of the UE, the capability report indicating a target beam prediction accuracy, means for transmitting a request to perform a beam prediction task aligned with the capability report, and/or means for receiving, based at least in part on the request, a beam prediction result satisfying the target beam prediction accuracy indicated in the capability report. The means for the network node to perform operations described herein may include, for example, one or more of communication manager 150, transmit processor 220, Tx MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the Tx MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

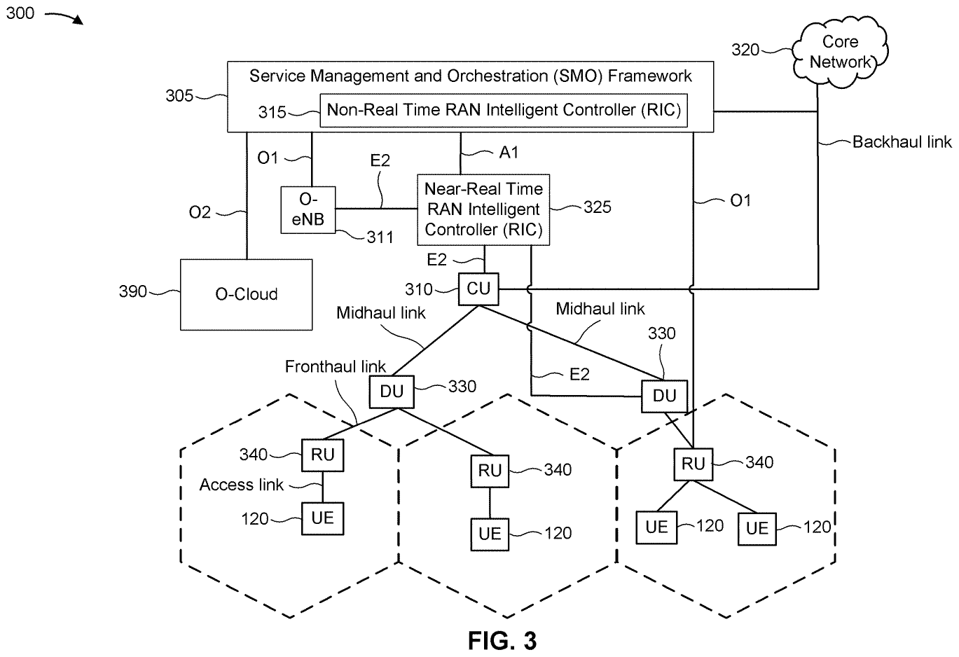

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an Ol interface) or via creation of RAN management policies (such as Al interface policies).

As indicated above, FIG. 3 is provided as an example. Other examples may differ from what is described with regard to FIG. 3.

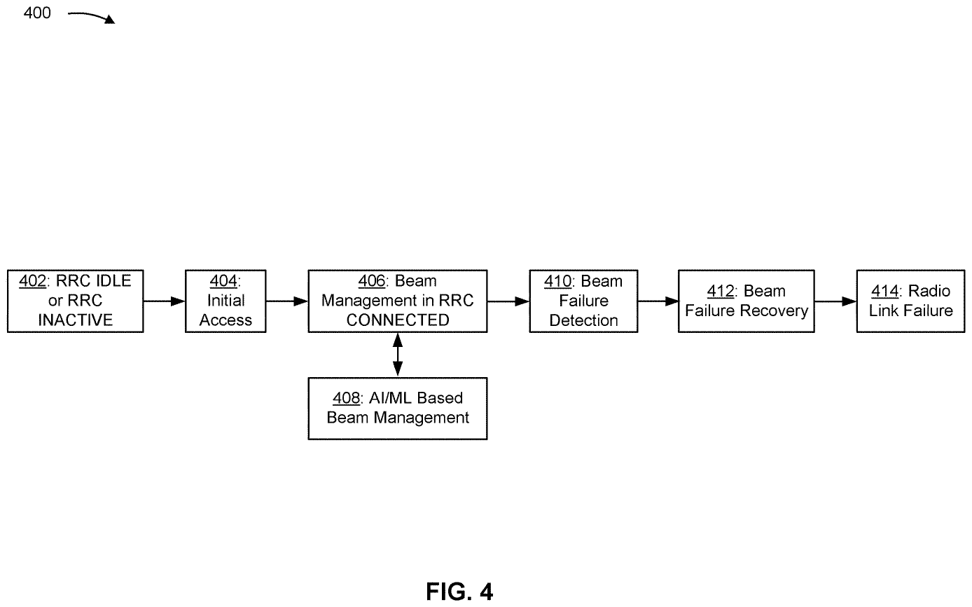

FIG. 4 is a diagram illustrating an example 400 of beam management, in accordance with the present disclosure.

As shown by reference number 402, a UE may initially be in an RRC idle state or an RRC inactive state. As shown by reference number 404, the UE may perform an initial access. As shown by reference number 406, the UE may perform a beam management after entering an RRC connected state. The beam management may include P1, P2, and/or P3 beam management procedures. The P1 beam management procedure may be a beam selection procedure, an initial beam acquisition procedure, a beam sweeping procedure, a cell search procedure, and/or a beam search procedure. The P2 beam management procedure may be a beam refinement procedure, a network node beam refinement procedure, a TRP beam refinement procedure, and/or a transmit beam refinement procedure. The P3 beam management procedure may be a beam refinement procedure, a UE beam refinement procedure, and/or a receive beam refinement procedure. As shown by reference number 408, the UE may also perform beam management using an AI/ML-based approach. The beam management using the AI/ML-based approach may use an AI/ML model in a spatial domain, a time domain, and/or a frequency domain, which may reduce signaling overhead and latency and improve a beam selection accuracy. The AI/ML model may be associated with a lifecycle management, which may involve a model training, model deployment, model inference, model monitoring, and/or model updating. As shown by reference number 410, the UE may perform a beam failure detection (BFD), which may be based at least in part on measurements obtained during the beam management after entering the RRC connected mode. As shown by reference number 412, the UE may perform a beam failure recovery (BFR) based at least in part on the BFD. As shown by reference number 414, when the BFR is not successful, the UE may declare a radio link failure (RLF).

As indicated above, FIG. 4 is provided as an example. Other examples may differ from what is described with regard to FIG. 4.

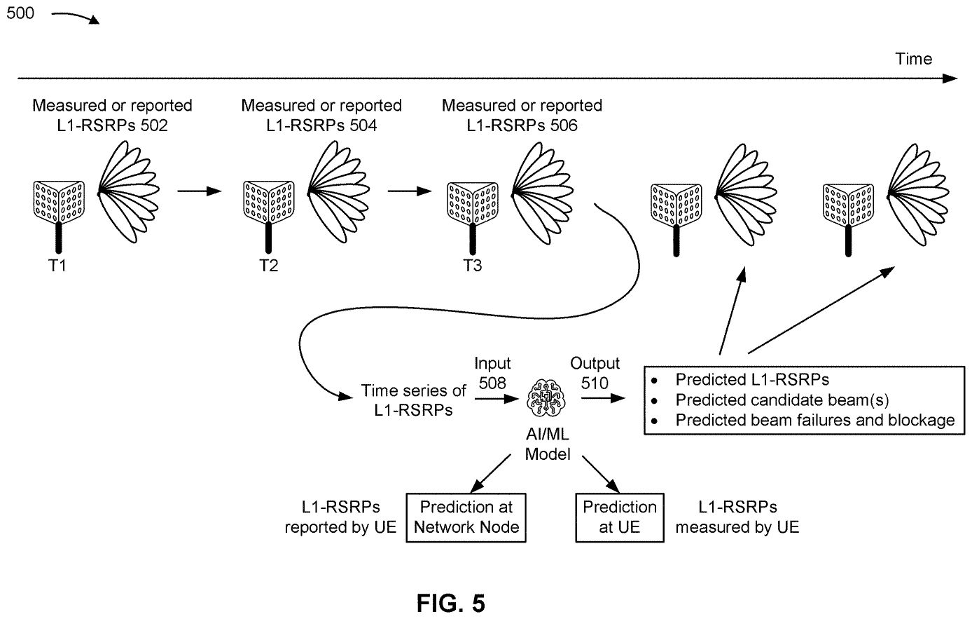

FIG. 5 is a diagram illustrating an example 500 of an AI/ML-based predictive beam management, in accordance with the present disclosure.

As shown by reference number 502, in an AI/ML-based predictive beam management, a network node may, at a first time, transmit a plurality of first channel state information reference signals (CSI-RSs) or synchronization signal blocks (SSBs). The first CSI-RSs/SSBs may be associated with first channel measurement resources (CMRs). A UE may perform first layer 1 RSRP (L1-RSRP) and/or signal-to-interference-plus-noise ratio (SINR) measurements based at least in part on the plurality of first CSI-RSs/SSBs. The UE may report the first L1-RSRP/SINR measurements to the network node. As shown by reference number 504, the network node may, at a second time, transmit a plurality of second CSI-RSs/SSBs. The second CSI-RSs/SSBs may be associated with second CMRs. The UE may perform second L1-RSRP/SINR measurements based at least in part on the plurality of second CSI-RSs/SSBs. The UE may report the second L1-RSRP/SINR measurements to the network node. As shown by reference number 506, the network node may, at a third time, transmit a plurality of third CSI-RSs/SSBs. The third CSI-RSs/SSBs may be associated with third CMRs. The UE may perform third L1-RSRP/SINR measurements based at least in part on the plurality of third CSI-RSs/SSBs. The UE may report the third L1-RSRP/SINR measurements to the network node.

As shown by reference number 508, a time series of L1-RSRP/SINR measurements (e.g., the first, second, and third L1-RSRP/SINR measurements) may be provided as an input to an AI/ML model capable of performing the AI/ML-based beam prediction. The AI/ML model may run on either the network node or the UE. When the AI/ML-based beam prediction is performed at the network node, the input may be L1-RSRP/SINR measurements reported by the UE. When the AI/ML-based beam prediction is performed at the UE, the input may be L1-RSRP/SINR measurements measured by the UE. As shown by reference number 510, the AI/ML model may produce an output based at least in part on the input, where the output may indicate predicted L1-RSRP/SINR measurements, predicted candidate beam(s), and/or predicted beam failure/blockage. For example, the output may be based at least in part on the time series of L1-RSRP/SINR measurements. The AI/ML-based beam prediction may result in a reduced UE power or UE-specific reference signal overhead, as well as better latency and throughput.

As indicated above, FIG. 5 is provided as an example. Other examples may differ from what is described with regard to FIG. 5.

AI/ML-based predictive beam management may involve beam management using AI/ML. In traditional beam management procedures, beam qualities/failures may be identified via measurements, which may involve more power/overhead for achieving good performance. A beam accuracy may be limited due to restrictions on power/overhead, and latency/throughput may be impacted by beam resuming efforts. AI/ML-based predictive beam management may provide predictive beam management in a spatial domain, a time domain, and/or a frequency domain, which may result in power/overhead reduction and/or accuracy/latency/throughput improvement. AI/ML-based predictive beam management may predict non-measured beam qualities, which may result in lower power/overhead or better accuracy. For example, AI/ML-based predictive beam management may predict future beam blockage/failure, which may result in better latency/throughput. AI/ML-based predictive beam management may be useful because beam prediction is a highly non-linear problem. Predicting future Tx beam qualities may depend on a UE's moving speed/trajectory, Rx beams used or to be used, and/or interference, which may be difficult to model via conventional statistical signaling processing techniques.

AI/ML-based predictive beam management may involve the prediction of beams via AI/ML at the UE or at a network node, which may involve a tradeoff between performance and UE power. In order to predict future DL-Tx beam qualities, the UE may have more observations (via measurements) than the network node (via UE feedbacks). Thus, beam prediction at the UE may outperform beam prediction at the network node, but may involve more UE power consumption. Model training may occur at the network node or at the UE. For model training at the network node, data may be collected via an air interface or via application-layer approaches. For model training at the UE, additional UE computation/buffering capabilities may be used for model training and data storage.

For an AI/ML-based predictive beam management, a first case of beam management and a second case of beam management may be supported for characterization and baseline performance evaluations. In the first case, a spatial domain downlink beam prediction for a Set A of beams may be based at least in part on measurement results of a Set B of beams. In the second case, a temporal downlink beam prediction for a Set A of beams may be based at least in part on historic measurement results of a Set B of beams.

For the first case and the second case, a first alternative and a second alternative may be defined. In the first alternative, beams in Set A and beams in Set B may be in the same frequency range. With respect to the first case, the beams in Set B may be a subset of the beams in Set A. A quantity of beams in Set A and a quantity of beams in Set B may be defined. The beams in Set B may be determined from the beams in Set A based at least in part on a fixed pattern or a random pattern. In the second alternative, the beams in Set A may be different than the beams in Set B (e.g., the beams in set B may not be a subset of the beams in Set A). For example, the beams in Set A may be associated with narrow beams, and the beams in Set B may be associated with wide beams. A quantity of beams in Set A and a quantity of beams in Set B may be defined. A quasi-co-location (QCL) relation may be defined between beams in Set A and beams in Set B. With respect to the first alternative and the second alternative, Set A may be associated with a downlink beam prediction and Set B may be associated with a downlink beam measurement. A codebook construction for Set A and a codebook construction for Set B may be defined.

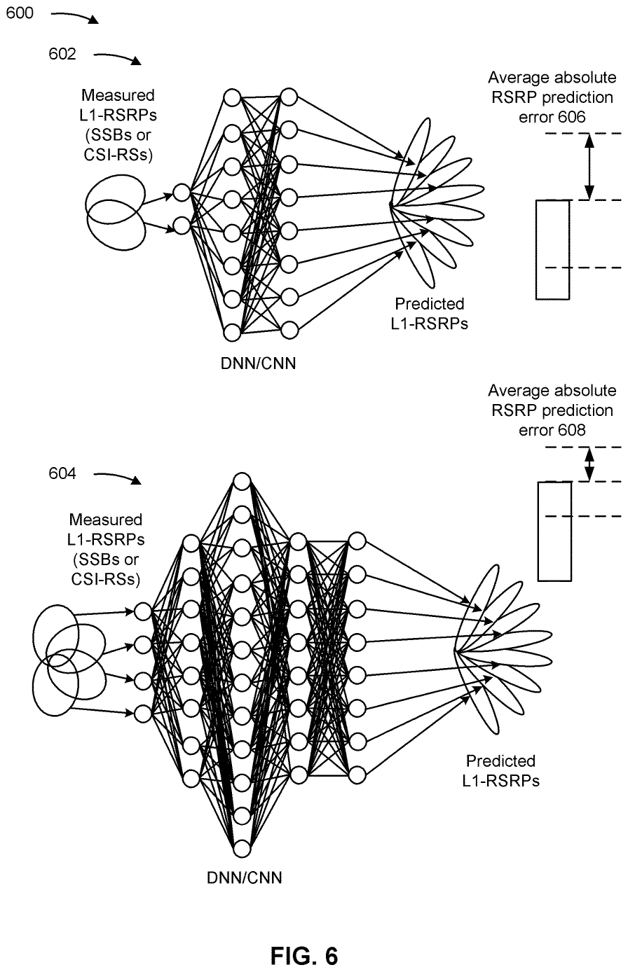

FIG. 6 is a diagram illustrating an example 600 of an AI/ML model complexity, in accordance with the present disclosure.

As shown by reference number 602, first L1-RSRP measurements, which may be based at least in part on first SSBs and/or first CSI-RSs, may be provided as an input to a first AI/ML model. The first AI/ML model may be based at least in part on a deep neural network (DNN) or a convolutional neural network (CNN). A complexity of the DNN/CNN may dynamically vary depending on priorities of different AI/ML tasks. The first AI/ML model may provide, as an output, first predicted L1-RSRP measurements. The first predicted L1-RSRP measurements may be associated with narrow beams, which may be transmitted using CSI-RSs. The first predicted L1-RSRP measurements may be based at least in part on the input of the first L1-RSRP measurements. The first predicted L1-RSRP measurements may be associated with a first average absolute RSRP prediction error 606.

As shown by reference number 604, second L1-RSRP measurements, which may be based at least in part on second SSBs and/or second CSI-RSs, may be provided as an input to a second AI/ML model. The second AI/ML model may be based at least in part on a DNN or a CNN. The second AI/ML model may provide, as an output, second predicted L1-RSRP measurements. The second predicted L1-RSRP measurements may be associated with narrow beams, which may be transmitted using CSI-RSs. The second predicted L1-RSRP measurements may be based at least in part on the input of the second L1-RSRP measurements. The second predicted L1-RSRP measurements may be associated with a second average absolute RSRP prediction error 608.

The second AI/ML model may be associated with a wider and/or deeper DNN/CNN as compared to the first AI/ML model, which may be based at least in part on the first average absolute RSRP prediction error 606 being associated with a greater average absolute RSRP prediction error and the second average absolute RSRP prediction error 608 being associated with a lower average absolute RSRP prediction error. For example, the wider and/or deeper DNN/CNN may be needed when a more accurate beam prediction is needed.

As indicated above, FIG. 6 is provided as an example. Other examples may differ from what is described with regard to FIG. 6.

In an AI/ML-based predictive beam management, a beam prediction accuracy may depend on a complexity of an AI/ML model. When an identical input/output dimension is assumed (e.g., the number of L1-RSRP measurements associated with the input is the same as the number of predicted L1-RSRP measurements associated with the output), a deeper or wider AI/ML model may achieve better performance. When an identical output dimension but a different input dimension/occasion are assumed, an AI/ML model with a more complex input dimension/occasion may provide a better beam prediction accuracy, but may involve a deeper or wider neural network. Regardless of the input/output dimensions, a minimum amount of data to train a more complex AI/ML model may be more than a minimum amount of data to train a less complex AI/ML model.

A network node may schedule a UE to perform a beam prediction task, but may be unaware of a beam prediction capability of the UE. Different UEs may have different capabilities in terms of beam prediction. Some UEs may have dedicated hardware for beam prediction, while some UEs may share hardware used for beam prediction with other tasks. The other tasks may be associated with a higher priority, so when the other tasks are running, less hardware resources may be allocated for the beam prediction. When the network node schedules the UE to perform the beam prediction task, the network node may be unaware of a complexity level of AI/ML models that are able to be run by the UE. The network node may also be unaware of whether the UE is able to perform the beam prediction task in accordance with a certain accuracy level. The UE may attempt to perform the beam prediction task based at least in part on the scheduling by the network node. However, depending on the UE's capability, the UE may be unable to perform the beam prediction task, and attempting to perform the beam prediction task may overload the UE and cause the UE to malfunction. In one example, the UE may be able to perform the beam prediction task when no higher priority applications are running, but when a higher priority application is triggered, the UE may no longer be able to perform the beam prediction task. In one example, the UE may attempt to perform the beam prediction task, but a limited capability of the UE may result in a relatively high probability of beam prediction inaccuracy.

In various aspects of techniques and apparatuses described herein, a UE may transmit, to a network node, a capability report associated with a beam prediction capability of the UE. The capability report may indicate a target beam prediction accuracy (e.g., a required beam prediction accuracy or a beam prediction accuracy threshold). The target beam prediction accuracy may correspond to an average absolute RSRP beam prediction error (in dB). The capability report may indicate a quantity of reference signal resources indicated as measurement resources for beam prediction and/or types of reference signal resources indicated as measurement resources for beam prediction. The capability report may indicate a quantity of beams as prediction target beams and/or types of beams as prediction target beams. The network node may receive the capability report from the UE. The network node may determine a beam prediction task to be performed by the UE. The network node may verify that the beam prediction task is aligned with the capability report. For example, the network node may not assign a beam prediction task to the UE that the UE is unable to perform. The UE may receive, from the network node, a request to perform the beam prediction task, which may be aligned with the capability report. For example, the UE may receive a scheduling associated with the beam prediction task. The UE may perform the beam prediction task and generate a beam prediction result. The beam prediction result may satisfy the target beam prediction accuracy indicated in the capability report. For example, the beam prediction result may be associated with an accuracy level that satisfies the target beam prediction accuracy. The UE may transmit, to the network node, the beam prediction result. In some aspects, since the beam prediction task may be assigned to the UE based at least in part on the UE's capability, the UE may be able to perform the beam prediction task without malfunctioning, thereby improving a performance of the UE.

In some aspects, the UE may transmit the capability report to the network node, where the capability report may be based at least in part on a tradeoff between a beam prediction accuracy and an AI/ML model complexity. The capability report may indicate various parameters associated with a UE-side beam prediction. For example, the capability report may indicate the target beam prediction accuracy (e.g., a supported beam prediction accuracy). The capability report may indicate the quantity of reference signal resources indicated as measurement resources for beam prediction and/or types of reference signal resources indicated as measurement resources for beam prediction (e.g., a supported Set B beam number and type). The capability report may indicate a quantity of beams as prediction target beams and/or types of beams as prediction target beams (e.g., a supported Set A beam number and type). Set B may be associated with reference signal resources for downlink beam measurements and Set A may be associated with reference signal resources for downlink beam predictions.

In some aspects, a hardware-based AI/ML model may enable a more dynamically altered model complexity, and thus a higher beam prediction accuracy, depending on priorities of different AI/ML tasks and/or a UE preference in terms of power saving. The UE may dynamically update related capabilities based at least in part on a dynamic computational resource rebalance. For example, when the UE dynamically alters its AI/ML model complexity, the UE may dynamically update the related capabilities. The network node may assign beam prediction tasks to the UE based at least in part on the updated capabilities of the UE.

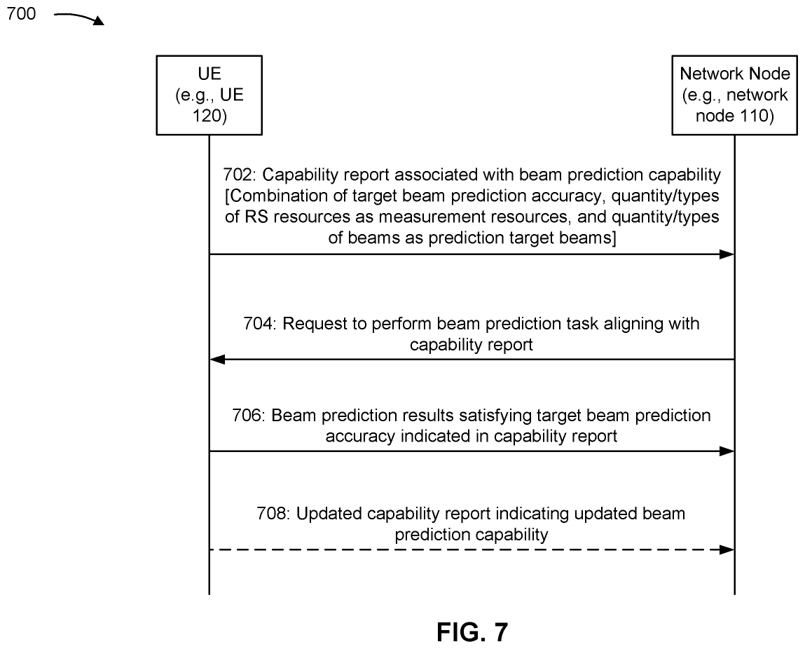

FIG. 7 is a diagram illustrating an example 700 associated with transmitting a capability report indicating a beam prediction capability of a UE, in accordance with the present disclosure. As shown in FIG. 7, example 700 includes communication between a UE (e.g., UE 120) and a network node (e.g., network node 110). In some aspects, the UE and the network node may be included in a wireless network, such as wireless network 100.

As shown by reference number 702, the UE may transmit, to the network node, a capability report associated with a beam prediction capability of the UE (e.g., the UE may output the capability report, and/or the network node may obtain the capability report). The UE may transmit the capability report via RRC signaling during an initial access. The capability report may indicate a target beam prediction accuracy (or required beam prediction accuracy, or beam prediction accuracy threshold) associated with the UE. In some aspects, the target beam prediction accuracy may be associated with an average prediction error, a maximum prediction error, and/or a standard predefined prediction error, which may be associated with the beam prediction capability of the UE. The average prediction error, the maximum prediction error, and/or the standard predefined prediction error may be based at least in part on reporting a single value across a plurality of beams associated with prediction target beams, or may be based at least in part on reporting multiple values for the plurality of beams associated with the prediction target beams. The average prediction error, the maximum prediction error, and the standard predefined prediction error may each be associated with an LI-RSRP, an LI-SINR, a rank indicator (RI), and/or a CQI.

In some aspects, the capability report may indicate a quantity of reference signal resources indicated as measurement resources for beam prediction, and/or types of reference signal resources indicated as measurement resources for beam prediction. The types of reference signal resources indicated as measurement resources for beam prediction may be associated with reference signal resources with a certain periodicity, reference signal resources with a single port, and/or reference signal resources with multiple ports. The capability report may indicate a quantity of historical time domain measurement occasions used as inputs for the beam prediction, and/or an interval between adjacent historical time domain occasions used as inputs for the beam prediction.

In some aspects, the capability report may indicate a quantity of beams as prediction target beams, and/or types of beams as prediction target beams. The types of beams indicated as prediction target beams may be associated with beams that carry reference signal resources configured as measurement resources, beams that do not carry reference signal resources configured as measurement resources, beams that are periodically transmitted, and/or beams that are not periodically transmitted. The capability report may indicate a quantity of upcoming time domain occasions predicted for beams as the prediction target beams, and/or an interval between adjacent upcoming time domain occasions predicted for the beams as the prediction target beams.

In some aspects, the UE may perform a UE capability reporting that considers tradeoffs between a beam prediction accuracy and an AI/ML model complexity. The UE may report, to the network node and as part of a UE capability on beam prediction, the target beam prediction accuracy. The UE may report, to the network node and as part of the UE capability on beam prediction, the quantity and/or type of reference signal resources indicated as measurement resources (e.g., resources associated with a Set B). The UE may report, to the network node and as part of the UE capability on beam prediction, the quantity and/or type of beams (or reference signal resources) as prediction target beams (e.g., beams and/or resources associated with a Set A). The UE may report, to the network node and as part of the UE capability on beam prediction, one or more combinations of the target beam prediction accuracy, the quantity and/or type of reference signal resources indicated as measurement resources, and/or the quantity and/or type of beams as prediction target beams. The UE may transmit, to the network node, the capability report that indicates the one or more combinations as part of the UE's capability for beam prediction.

In some aspects, the UE may expect the network node to only configure or indicate beam prediction requests that satisfy reported capabilities, as indicated in the UE capability reporting. For example, the UE may expect the network node to only configure or indicate beam prediction requests that satisfy the one or more combinations. In some aspects, the UE may perform the UE capability reporting via RRC signaling during the initial access. In one example, the UE may perform additional UE capability reporting via dynamic updates after the initial access.

In some aspects, the UE may report, to the network node, the target beam prediction accuracy. In some aspects, as part of reporting the target beam prediction accuracy, the UE may report an average (or absolute) L1-RSRP measurement, L1-SINR measurement, RI, and/or CQI prediction error (e.g., in terms of a dBm for an LI-RSRP measurement). The UE may report the average (or absolute) L1-RSRP measurement, L1-SINR measurement, RI, and/or CQI prediction error based at least in part on reporting a single value, which may take an average across a plurality of prediction target beams. The UE may report the average (or absolute) L1-RSRP measurement, L1-SINR measurement, RI, and/or CQI prediction error based at least in part on reporting multiple values, where each value may correspond to each beam of the prediction target beams, and where the prediction target beams may be associated with a particular combination of the target beam prediction accuracy, a quantity and/or type of reference signal resources indicated as measurement resources, and/or a quantity and/or type of beams as prediction target beams.

In some aspects, as part of reporting the target beam prediction accuracy, the UE may report a maximum (or absolute) L1-RSRP measurement, L1-SINR measurement, RI, and/or CQI prediction accuracy (e.g., in terms of a dBm for an L1-RSRP measurement). The UE may report the maximum (or absolute) L1-RSRP measurement, L1-SINR measurement, RI, and/or CQI prediction error based at least in part on reporting a single value, which may be an average across a plurality of prediction target beams. The UE may report the maximum (or absolute) L1-RSRP measurement, L1-SINR measurement, RI, and/or CQI prediction accuracy based at least in part on reporting multiple values, where each value may correspond to each beam of the prediction target beams, and where the prediction target beams may be associated with the particular combination of the target beam prediction accuracy, the quantity and/or type of reference signal resources indicated as measurement resources, and/or the quantity and/or type of beams as prediction target beams.

In some aspects, as part of reporting the target beam prediction accuracy, the UE may report a standard predefined L1-RSRP measurement, L1-SINR measurement, RI, and/or CQI prediction accuracy/uncertain level. The UE may report the standard predefined L1-RSRP measurement, L1-SINR measurement, RI, and/or CQI prediction error based at least in part on reporting a single value, which may be an average across a plurality of prediction target beams. The UE may report the standard predefined LI-RSRP measurement, L1-SINR measurement, RI, and/or CQI prediction accuracy based at least in part on reporting multiple values, where each value may correspond to each beam of the prediction target beams, and where the prediction target beams may be associated with the particular combination of the target beam prediction accuracy, the quantity and/or type of reference signal resources indicated as measurement resources, and/or the quantity and/or type of beams as prediction target beams.

In some aspects, the UE may report, to the network node, the quantity and/or type of reference signal resources indicated as measurement resources (e.g., numbers/types of Set B beams), and/or the quantity and/or type of beams as prediction target beams (e.g., numbers/types of Set A beams). In some aspects, certain types of reference signal resources may be configured/indicated by the network node as measurement resources for beam prediction (e.g., Set A), where the reference signal resources may be associated with a periodicity. Certain types of reference signal resources may be configured/indicated by the network node as measurement resources for beam prediction (e.g., Set B), where the reference signal resources may be associated with single-port CSI-RSs or SSBs, or multiple-port CSI-RSs.

In some aspects, certain types of beams may be predicted and/or reported by the UE. Beams that may be predicted and/or reported may include predicted beams that carry reference signal resources configured as measurement resources, or predicted beams that do not carry reference signal resources configured as measurement resources. Beams that may be predicted and/or reported may include predicted beams that are periodically transmitted by the network node, or predicted beams that are not transmitted by the network node. Predicted beams that are periodically transmitted may be transmitted with a periodicity that is longer than the reference signal resources indicated as measurement resources (e.g., via a CSI-RS or SSB). For a time domain beam prediction, beams that may be predicted and/or reported may be associated with a quantity of future time domain occasions predicted for the beams. For the time domain beam prediction, beams that may be predicted and/or reported may be associated with an interval between adjacent future time domain occasions predicted for the beams.

In some aspects, the capability report may indicate one or more combinations of UE capabilities, where a combination may be based at least in part on the target beam prediction accuracy, the quantity of reference signal resources indicated as measurement resources and/or the types of reference signal resources indicated as measurement resources, and/or the one or more of a quantity of beams as prediction target beams and/or the types of beams as prediction target beams. The capability report may indicate the one or more combinations of UE capabilities based at least in part on a standard predefinition (e.g., a predefinition indicated in a 3GPP Technical Specification) or a pre-configuration received from the network node. In some aspects, the capability report may indicate one or more sets of combinations of UE capabilities, where a set of combinations of UE capabilities from the one or more sets of combinations of UE capabilities may indicate the one or more combinations of UE capabilities. The set of combinations of UE capabilities may be simultaneously activated for the UE.

In some aspects, the UE may perform the capability reporting in accordance with a capability reporting framework. In some aspects, the capability reporting framework may be standard predefined and/or preconfigured by the network node. The standard predefinition, a network node reconfiguration, and/or UE reported capabilities may be divided into different cases, depending on which mechanism is used to carry UE reported prediction results. For example, the UE may transmit a medium access control control element (MAC-CE) to carry the UE reported prediction results. Alternatively, the UE may transmit a channel state information (CSI) report to carry the UE reported prediction results. The CSI report may be a periodic CSI report, a semi-persistent CSI report, or an aperiodic CSI report.

In some aspects, the capability reporting framework may be based at least in part on simultaneously activated combinations. The UE may report one or multiple sets of combinations, where each set may include one or multiple combinations, and where each combination may refer to a particular target beam prediction accuracy, quantity and/or type of reference signal resources indicated as measurement resources, and/or quantity and/or type of beams as prediction target beams. Each set of combinations may be simultaneously activated for the UE, such that the UE may be able to simultaneously carry out beam prediction tasks regarding different combinations reported in each respective set.

As shown by reference number 704, the UE may receive from the network node, a request to perform the beam prediction task aligned with the capability report (e.g., the UE may output the request, and/or the network node may obtain the request). The beam prediction task may correspond to the target beam prediction accuracy, the quantity of reference signal resources indicated as measurement resources and/or the types of reference signal resources indicated as measurement resources, and/or the one or more of a quantity of beams as prediction target beams and/or the types of beams as prediction target beams. The network node may determine to schedule the UE to perform the beam prediction task based at least in part on the capability report received from the UE. For example, when the network node has a particular beam prediction task that is capable of being performed by the UE, the network node may request the UE to perform that beam prediction task. Otherwise, the network node may request another UE to perform that beam prediction task.

As shown by reference number 706, the UE may transmit, to the network node and based at least in part on the request, a beam prediction result satisfying the target beam prediction accuracy indicated in the capability report (e.g., the UE may output the beam prediction result, and/or the network node may obtain the beam prediction result). The beam prediction result may be associated with a certain accuracy level, as indicated in the capability report. In some aspects, the UE may transmit the beam prediction result (or UE reported prediction results) via a MAC-CE or a CSI report, which may be a periodic CSI report, a semi-persistent CSI report, or an aperiodic CSI report.

As shown by reference number 708, the UE may transmit, to the network node and after the initial access, an updated capability report indicating an updated beam prediction capability of the UE (e.g., the UE may output the updated capability report, and/or the network node may obtain the updated capability report). For example, the capability report may be associated with a first combination of UE capabilities and the updated capability report may be associated with a second combination of UE capabilities, where the second combination of UE capabilities may be different than the first combination of UE capabilities.

In some aspects, the UE may be capable of dynamic capability updates. The UE may dynamically update the capability report, to form the updated capability report, and the UE may transmit the updated capability report to the network node. The UE may transmit the updated capability report via RRC signaling, a MAC-CE, or uplink control information (UCI). In some aspects, the UE may report multiple combinations, or multiple sets of combinations, during the initial access. One combination may be associated with a default combination. The UE may dynamically update the default combination by reporting another identifier, which may be associated with another combination that is to be the new default combination.

As an example, an AI/ML model for beam prediction, which may be formed using an AI/ML inference neural network, may be implemented using dedicated hardware. A depth and width associated with the AI/ML model may be dynamically altered. Other applications with higher priority, as compared to the AI/ML model, may also share the same hardware, but the other applications may not always be activated.

The other applications may be transparent to the network node. Such applications may involve UE autonomous mobile payload element (MPE) detection, or real-time demodulation or decoding. When a high priority application is activated, which may be transparent to the network node, at least some of the hardware resources originally used by the UE for AI/ML-based beam prediction may be reallocated for the high priority application. In this case, the UE may signal, to the network node, a dynamic capability update to indicate an updated UE capability.

As indicated above, FIG. 7 is provided as an example. Other examples may differ from what is described with regard to FIG. 7.

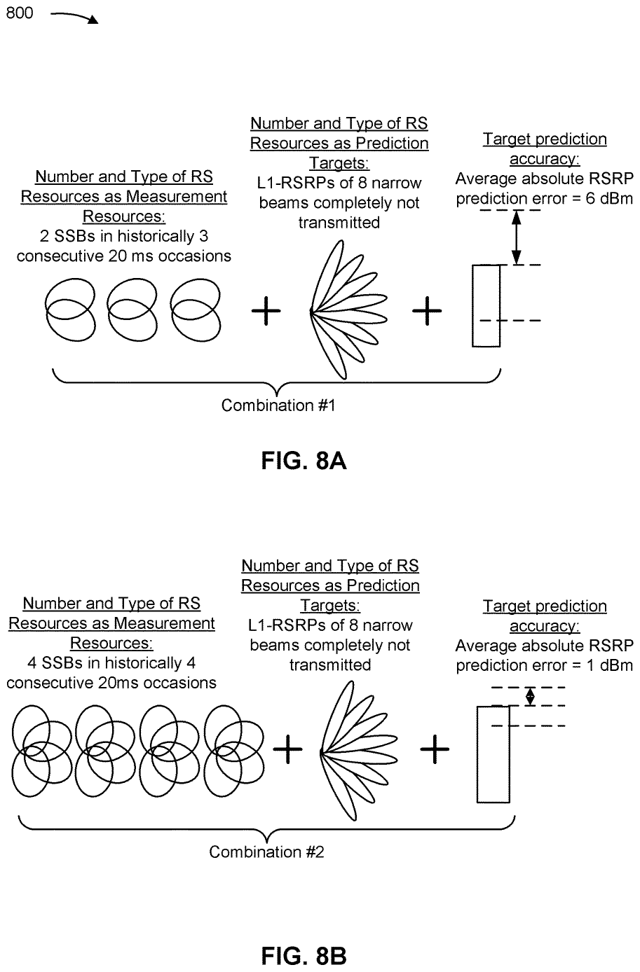

FIGS. 8A-8B are diagrams illustrating examples 800 associated with transmitting a capability report indicating a beam prediction capability of a UE, in accordance with the present disclosure.

In some aspects, a UE may transmit, to a network node, a capability report. The capability report may indicate a quantity and type of reference signal resources indicated as measurement resources, a quantity and type of reference signal resources as prediction target beams, and/or a target beam prediction accuracy. The capability report may indicate, as its UE capability on beam prediction, one or multiple combinations of the quantity and type of reference signal resources indicated as measurement resources, the quantity and type of reference signal resources as prediction target beams, and/or the target beam prediction accuracy.

As shown in FIG. 8A, a UE may transmit, to a network node, a capability report that indicates a first combination. The capability report may indicate, for the quantity and type of reference signal (RS) resources indicated as measurement resources, two SSBs in historically three consecutive 20 ms occasions. The capability report may indicate, for the quantity and type of reference signal resources as prediction target beams, L1-RSRP measurements of 8 narrow beams that are not transmitted. The capability report may indicate, for the target beam prediction accuracy, an average absolute RSRP prediction error equal to 6 dBm. The first combination may be associated with a first set of values.

As shown in FIG. 8B, a UE may transmit, to a network node, a capability report that indicates a second combination. The capability report may indicate, for the quantity and type of reference signal resources indicated as measurement resources, four SSBs in four consecutive historical 20 ms occasions. The capability report may indicate, for the quantity and type of reference signal resources as prediction target beams, L1-RSRP measurements of 8 narrow beams that are not transmitted. The capability report may indicate, for the target beam prediction accuracy, an average absolute RSRP prediction error equal to one dBm. The second combination may be associated with a second set of values.

As indicated above, FIGS. 8A-8B are provided as examples. Other examples may differ from what is described with regard to FIGS. 8A-8B.

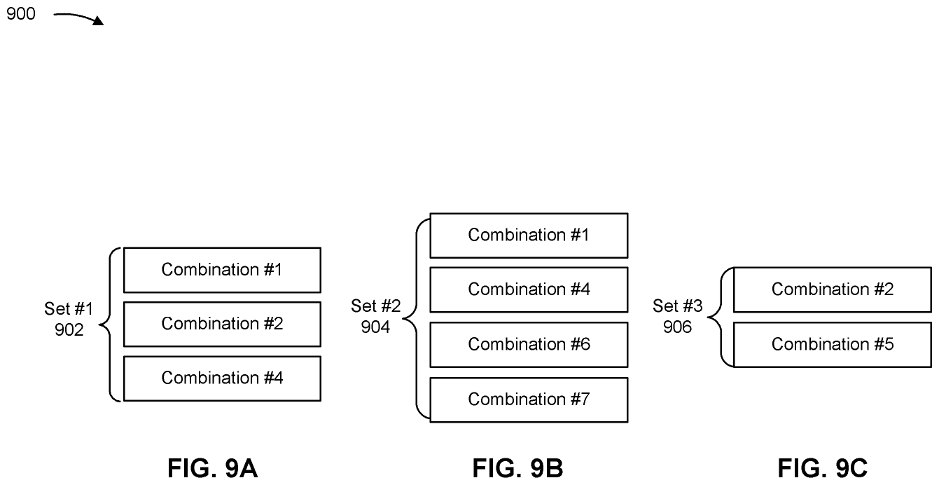

FIGS. 9A, 9B, and 9C are diagram illustrating examples 900 associated with transmitting a capability report indicating a beam prediction capability of a UE, in accordance with the present disclosure.

In some aspects, a UE may report one or more sets of combinations, where each set may include one or more combinations, and where each combination may refer to a particular target beam prediction accuracy, quantity and/or type of reference signal resources indicated as measurement resources, and/or quantity and/or type of beams as prediction target beams. As shown in FIG. 9A, a first set 902 may include a first combination, a second combination, and a fourth combination. As shown in FIG. 9B, a second set 904 may include the first combination, the fourth combination, a sixth combination, and a seventh combination. As shown in FIG. 9C, a third set 906 may include the second combination and a fifth combination. The UE may be able to simultaneously carry out beam prediction tasks regarding different combinations reported in each respective set.

As indicated above, FIGS. 9A, 9B, and 9C are provided as examples. Other examples may differ from what is described with regard to FIGS. 9A, 9B, and 9C.

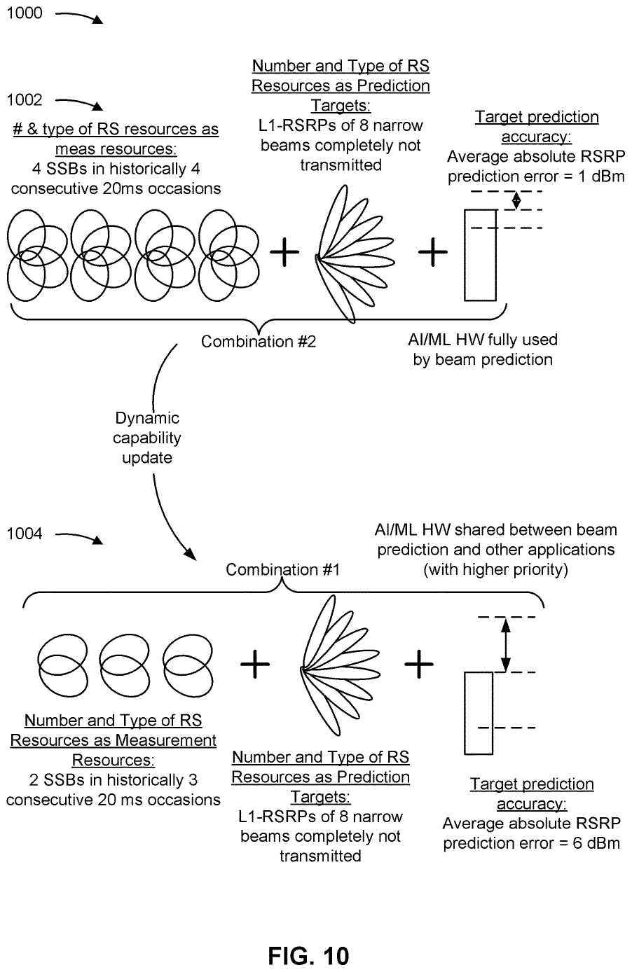

FIG. 10 is a diagram illustrating an example 1000 associated with transmitting a capability report indicating a beam prediction capability of a UE, in accordance with the present disclosure.

As shown by reference number 1002, a UE may transmit, to a network node, a capability report that indicates a second combination. The capability report may indicate, for the quantity and type of reference signal resources indicated as measurement resources, four SSBs in four consecutive historical 20 ms occasions. The capability report may indicate, for the quantity and type of reference signal resources as prediction target beams, L1-RSRP measurements of 8 narrow beams that are not transmitted. The capability report may indicate, for the target beam prediction accuracy, an average absolute RSRP prediction error equal to one dBm. The UE may be capable of the second combination when an AI/ML model of the UE uses hardware that is fully used for beam prediction. The hardware of the UE may be useable by other higher priority applications of the UE, but the other higher priority applications may not be activated when the UE uses the second combination.

As shown by reference number 1004, the UE may transmit, to the network node, an updated capability report that indicates a first combination. The updated capability report may indicate a dynamic capability update, where the first combination may be an update to the second combination that was previously transmitted by the UE. The UE may transmit the updated capability report based at least in part on one of the higher priority applications being activated by the UE, thereby consuming some of the hardware that was previously used only by the AI/ML model. The updated capability report may indicate, for the quantity and type of reference signal resources indicated as measurement resources, two SSBs in historically three consecutive 20 ms occasions. The updated capability report may indicate, for the quantity and type of reference signal resources as prediction target beams, L1-RSRP measurements of 8 narrow beams that are not transmitted. The updated capability report may indicate, for the target beam prediction accuracy, an average absolute RSRP prediction error equal to 6 dBm. The first combination may be associated with a first set of values. Since the first combination may be used when fewer hardware resources are available at the UE (e.g., due to the higher priority application being executed at the same time), the target prediction accuracy and/or the average absolute RSRP prediction error for the first combination may be more than a target prediction accuracy and/or an average absolute RSRP prediction error associated with the second combination, during which the hardware resources of the UE were not used by the other higher priority applications.

As indicated above, FIG. 10 is provided as an example. Other examples may differ from what is described with regard to FIG. 10.

FIG. 11 is a diagram illustrating an example process 1100 performed, for example, by a UE, in accordance with the present disclosure. Example process 1100 is an example where the UE (e.g., UE 120) performs operations associated with transmitting a capability report indicating a beam prediction capability of a UE.

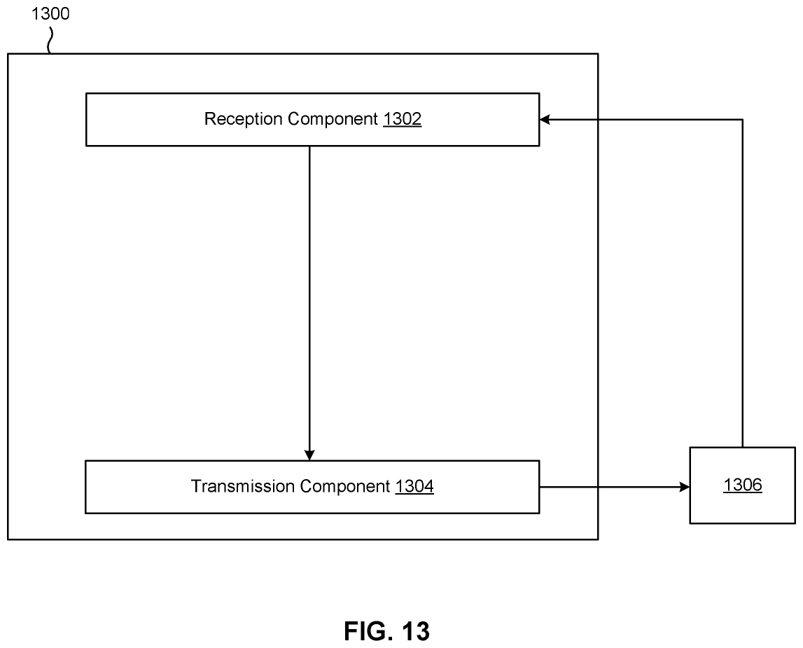

As shown in FIG. 11, in some aspects, process 1100 may include transmitting a capability report associated with a beam prediction capability of the UE, the capability report indicating a target beam prediction accuracy (block 1110). For example, the UE (e.g., using transmission component 1304, depicted in FIG. 13) may transmit a capability report associated with a beam prediction capability of the UE, the capability report indicating a target beam prediction accuracy, as described above.

As further shown in FIG. 11, in some aspects, process 1100 may include receiving a request to perform a beam prediction task aligned with the capability report (block 1120). For example, the UE (e.g., using reception component 1302, depicted in FIG. 13) may receive a request to perform a beam prediction task aligned with the capability report, as described above.

As further shown in FIG. 11, in some aspects, process 1100 may include transmitting, based at least in part on the request, a beam prediction result satisfying the target beam prediction accuracy indicated in the capability report (block 1130). For example, the UE (e.g., using transmission component 1304, depicted in FIG. 13) may transmit, based at least in part on the request, a beam prediction result satisfying the target beam prediction accuracy indicated in the capability report, as described above.

Process 1100 may include additional aspects, such as any single aspect or any combination of aspects described below and/or in connection with one or more other processes described elsewhere herein.

In a first aspect, the target beam prediction accuracy is associated with one or more of an average prediction error, a maximum prediction error, or a standard predefined prediction error, wherein the average prediction error, the maximum prediction error, or the standard predefined prediction error is based at least in part on reporting a single value across a plurality of beams associated with prediction target beams, or is based at least in part on reporting multiple values for the plurality of beams associated with the prediction target beams.

In a second aspect, alone or in combination with the first aspect, the average prediction error, the maximum prediction error, and the standard predefined prediction error are each associated with one or more of an L1-RSRP, an L1-SINR, an RI, or a CQI.

In a third aspect, alone or in combination with one or more of the first and second aspects, the capability report indicates one or more of a quantity of reference signal resources indicated as measurement resources for beam prediction, or types of reference signal resources indicated as measurement resources for beam prediction.

In a fourth aspect, alone or in combination with one or more of the first through third aspects, the types of reference signal resources indicated as measurement resources for beam prediction are associated with one or more of reference signal resources with a certain periodicity, reference signal resources with a single port, or reference signal resources with multiple ports.

In a fifth aspect, alone or in combination with one or more of the first through fourth aspects, the capability report indicates one or more of a quantity of historical time domain measurement occasions used as inputs for the beam prediction, or an interval between adjacent historical time domain occasions used as inputs for the beam prediction.

In a sixth aspect, alone or in combination with one or more of the first through fifth aspects, the capability report indicates one or more of a quantity of beams as prediction target beams, or types of beams as prediction target beams.

In a seventh aspect, alone or in combination with one or more of the first through sixth aspects, the types of beams indicated as prediction target beams are associated with one or more of beams that carry reference signal resources configured as measurement resources, beams that do not carry reference signal resources configured as measurement resources, beams that are periodically transmitted, or beams that are not periodically transmitted.

In an eighth aspect, alone or in combination with one or more of the first through seventh aspects, the capability report indicates one or more of a quantity of upcoming time domain occasions predicted for beams as the prediction target beams, or an interval between adjacent upcoming time domain occasions predicted for the beams as the prediction target beams.

In a ninth aspect, alone or in combination with one or more of the first through eighth aspects, transmitting the capability report comprises transmitting the capability report via RRC signaling during an initial access.

In a tenth aspect, alone or in combination with one or more of the first through ninth aspects, the capability report indicates one or more combinations of UE capabilities including a target beam prediction accuracy, one or more of a quantity of reference signal resources indicated as measurement resources or types of reference signal resources indicated as measurement resources, and one or more of a quantity of beams as prediction target beams or types of beams as prediction target beams, wherein the capability report indicates the one or more combinations of UE capabilities based at least in part on a standard predefinition or a pre-configuration.

In an eleventh aspect, alone or in combination with one or more of the first through tenth aspects, the capability report indicates one or more sets of combinations of UE capabilities, wherein a set of combinations of UE capabilities from the one or more sets of combinations of UE capabilities indicates the one or more combinations of UE capabilities, and the set of combinations of UE capabilities are configured to be simultaneously activated for the UE.

In a twelfth aspect, alone or in combination with one or more of the first through eleventh aspects, process 1100 includes transmitting, after an initial access, an updated capability report indicating an updated beam prediction capability of the UE, wherein the capability report is associated with a first combination of UE capabilities and the updated capability report is associated with a second combination of UE capabilities.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network node, in accordance with the present disclosure. Example process 1200 is an example where the network node (e.g., network node 110) performs operations associated with transmitting a capability report indicating a beam prediction capability of a UE.

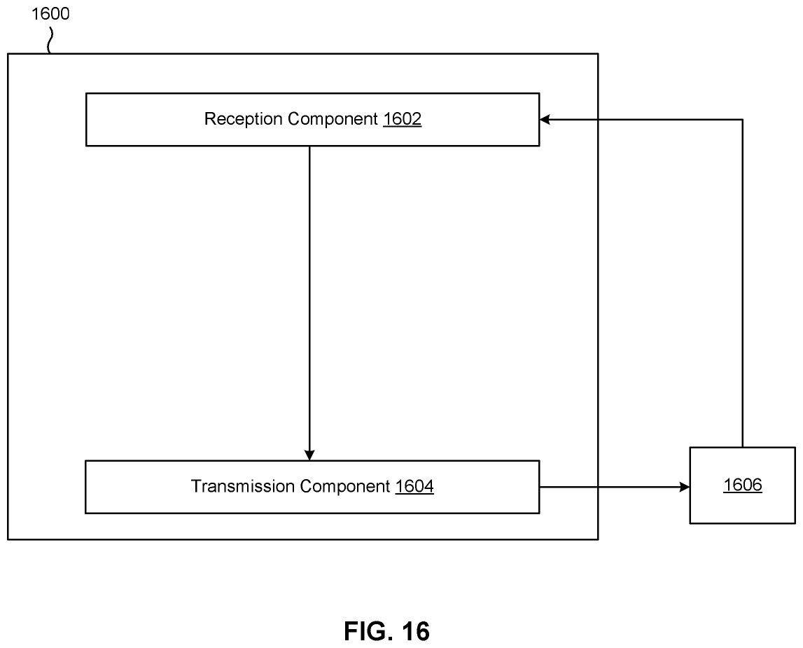

As shown in FIG. 12, in some aspects, process 1200 may include receiving a capability report associated with a beam prediction capability of the UE, the capability report indicating a target beam prediction accuracy (block 1210). For example, the network node (e.g., using reception component 1602, depicted in FIG. 16) may receive a capability report associated with a beam prediction capability of the UE, the capability report indicating a target beam prediction accuracy, as described above.

As further shown in FIG. 12, in some aspects, process 1200 may include transmitting a request to perform a beam prediction task aligned with the capability report (block 1220). For example, the network node (e.g., using transmission component 1604, depicted in FIG. 16) may transmit a request to perform a beam prediction task aligned with the capability report, as described above.

As further shown in FIG. 12, in some aspects, process 1200 may include receiving, based at least in part on the request, a beam prediction result satisfying the target beam prediction accuracy indicated in the capability report (block 1230). For example, the network node (e.g., using reception component 1602, depicted in FIG. 16) may receive, based at least in part on the request, a beam prediction result satisfying the target beam prediction accuracy indicated in the capability report, as described above.

Process 1200 may include additional aspects, such as any single aspect or any combination of aspects described below and/or in connection with one or more other processes described elsewhere herein.

In a first aspect, the target beam prediction accuracy is associated with one or more of an average prediction error, a maximum prediction error, or a standard predefined prediction error, wherein the average prediction error, the maximum prediction error, or the standard predefined prediction error is based at least in part on reporting a single value across a plurality of beams associated with prediction target beams, or is based at least in part on reporting multiple values for the plurality of beams associated with the prediction target beams.

In a second aspect, alone or in combination with the first aspect, the average prediction error, the maximum prediction error, and the standard predefined prediction error are each associated with one or more of an L1-RSRP, an L1-SINR, an RI, or a CQI.

In a third aspect, alone or in combination with one or more of the first and second aspects, the capability report indicates one or more of a quantity of reference signal resources indicated as measurement resources for beam prediction, or types of reference signal resources indicated as measurement resources for beam prediction.

In a fourth aspect, alone or in combination with one or more of the first through third aspects, the types of reference signal resources indicated as measurement resources for beam prediction are associated with one or more of reference signal resources with a certain periodicity, reference signal resources with a single port, or reference signal resources with multiple ports.

In a fifth aspect, alone or in combination with one or more of the first through fourth aspects, the capability report indicates one or more of a quantity of historical time domain measurement occasions used as inputs for the beam prediction, or an interval between adjacent historical time domain occasions used as inputs for the beam prediction.

In a sixth aspect, alone or in combination with one or more of the first through fifth aspects, the capability report indicates one or more of a quantity of beams as prediction target beams, or types of beams as prediction target beams.

In a seventh aspect, alone or in combination with one or more of the first through sixth aspects, the types of beams indicated as prediction target beams are associated with one or more of beams that carry reference signal resources configured as measurement resources, beams that do not carry reference signal resources configured as measurement resources, beams that are periodically transmitted, or beams that are not periodically transmitted.

In an eighth aspect, alone or in combination with one or more of the first through seventh aspects, the capability report indicates one or more of a quantity of upcoming time domain occasions predicted for beams as the prediction target beams, or an interval between adjacent upcoming time domain occasions predicted for the beams as the prediction target beams.

In a ninth aspect, alone or in combination with one or more of the first through eighth aspects, receiving the capability report comprises receiving the capability report via RRC signaling during an initial access.

In a tenth aspect, alone or in combination with one or more of the first through ninth aspects, the capability report indicates one or more combinations of UE capabilities comprising a target beam prediction accuracy, one or more of a quantity of reference signal resources indicated as measurement resources or types of reference signal resources indicated as measurement resources, and one or more of a quantity of beams as prediction target beams or types of beams as prediction target beams, wherein the capability report indicates the one or more combinations of UE capabilities based at least in part on a standard predefinition or a pre-configuration.

In an eleventh aspect, alone or in combination with one or more of the first through tenth aspects, the capability report indicates one or more sets of combinations of UE capabilities, wherein a set of combinations of UE capabilities from the one or more sets of combinations of UE capabilities indicates the one or more combinations of UE capabilities, and the set of combinations of UE capabilities are configured to be simultaneously activated for the UE.

In a twelfth aspect, alone or in combination with one or more of the first through eleventh aspects, process 1200 includes receiving, after an initial access, an updated capability report indicating an updated beam prediction capability of the UE, wherein the capability report is associated with a first combination of UE capabilities and the updated capability report is associated with a second combination of UE capabilities.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304.

In some aspects, the apparatus 1300 may be configured to perform one or more operations described herein in connection with FIGS. 7, 8A, 8B, 9A, 9B, 9C, and 10. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The transmission component 1304 may transmit a capability report associated with a beam prediction capability of the UE, the capability report indicating a target beam prediction accuracy. The reception component 1302 may receive a request to perform a beam prediction task aligned with the capability report. The transmission component 1304 may transmit, based at least in part on the request, a beam prediction result satisfying the target beam prediction accuracy indicated in the capability report. The transmission component 1304 may transmit, after an initial access, an updated capability report indicating an updated beam prediction capability of the UE, wherein the capability report is associated with a first combination of UE capabilities and the updated capability report is associated with a second combination of UE capabilities.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

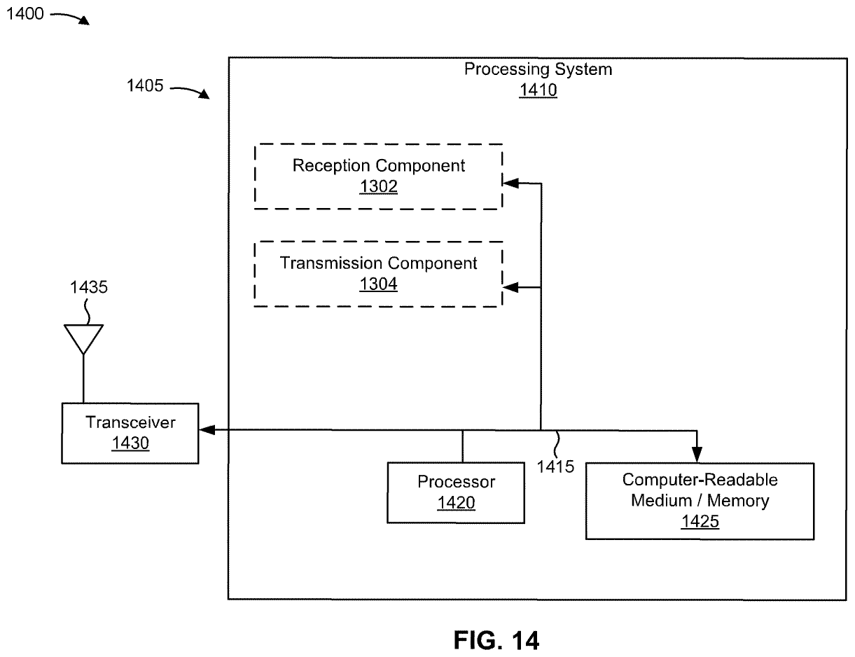

FIG. 14 is a diagram illustrating an example 1400 of a hardware implementation for an apparatus 1405 employing a processing system 1410, in accordance with the present disclosure. The apparatus 1405 may be a UE.

The processing system 1410 may be implemented with a bus architecture, represented generally by the bus 1415. The bus 1415 may include any number of interconnecting buses and bridges depending on the specific application of the processing system 1410 and the overall design constraints. The bus 1415 links together various circuits including one or more processors and/or hardware components, represented by the processor 1420, the illustrated components, and the computer-readable medium/memory 1425. The bus 1415 may also link various other circuits, such as timing sources, peripherals, voltage regulators, and/or power management circuits.

The processing system 1410 may be coupled to a transceiver 1430. The transceiver 1430 is coupled to one or more antennas 1435. The transceiver 1430 provides a means for communicating with various other apparatuses over a transmission medium. The transceiver 1430 receives a signal from the one or more antennas 1435, extracts information from the received signal, and provides the extracted information to the processing system 1410, specifically the reception component 1302. In addition, the transceiver 1430 receives information from the processing system 1410, specifically the transmission component 1304, and generates a signal to be applied to the one or more antennas 1435 based at least in part on the received information.

The processing system 1410 includes a processor 1420 coupled to a computer-readable medium/memory 1425. The processor 1420 is responsible for general processing, including the execution of software stored on the computer-readable medium/memory 1425. The software, when executed by the processor 1420, causes the processing system 1410 to perform the various functions described herein for any particular apparatus. The computer-readable medium/memory 1425 may also be used for storing data that is manipulated by the processor 1420 when executing software. The processing system further includes at least one of the illustrated components. The components may be software modules running in the processor 1420, resident/stored in the computer readable medium/memory 1425, one or more hardware modules coupled to the processor 1420, or some combination thereof.

In some aspects, the processing system 1410 may be a component of the UE 120 and may include the memory 282 and/or at least one of the TX MIMO processor 266, the Rx processor 258, and/or the controller/processor 280. In some aspects, the apparatus 1405 for wireless communication includes means for transmitting a capability report associated with a beam prediction capability of the UE, the capability report indicating a target beam prediction accuracy; means for receiving a request to perform a beam prediction task aligned with the capability report; and means for transmitting, based at least in part on the request, a beam prediction result satisfying the target beam prediction accuracy indicated in the capability report. The aforementioned means may be one or more of the aforementioned components of the apparatus 1300 and/or the processing system 1410 of the apparatus 1405 configured to perform the functions recited by the aforementioned means. As described elsewhere herein, the processing system 1410 may include the TX MIMO processor 266, the Rx processor 258, and/or the controller/processor 280. In one configuration, the aforementioned means may be the TX MIMO processor 266, the Rx processor 258, and/or the controller/processor 280 configured to perform the functions and/or operations recited herein.

FIG. 14 is provided as an example. Other examples may differ from what is described in connection with FIG. 14.

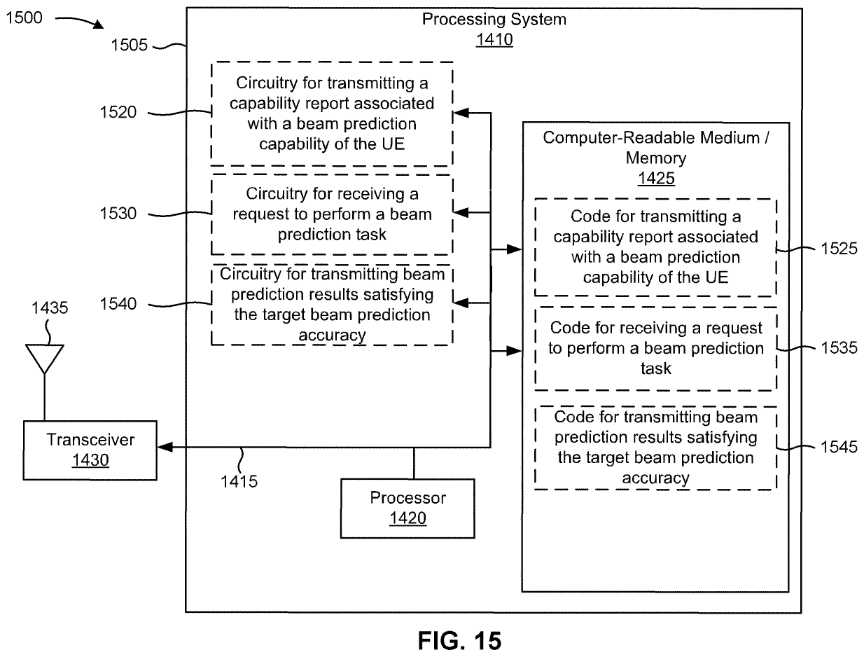

FIG. 15 is a diagram illustrating an example 1500 of an implementation of code and circuitry for an apparatus 1505, in accordance with the present disclosure. The apparatus 1505 may be a UE, or a UE may include the apparatus 1505.

As shown in FIG. 15, the apparatus 1505 may include circuitry for transmitting a capability report associated with a beam prediction capability of the UE, the capability report indicating a target beam prediction accuracy (circuitry 1520). For example, the circuitry 1520 may enable the apparatus 1505 to transmit a capability report associated with a beam prediction capability of the UE, the capability report indicating a target beam prediction accuracy.

As shown in FIG. 15, the apparatus 1505 may include, stored in computer-readable medium 1425, code for transmitting a capability report associated with a beam prediction capability of the UE, the capability report indicating a target beam prediction accuracy (code 1525). For example, the code 1525, when executed by processor 1420, may cause processor 1420 to cause transceiver 1430 to transmit a capability report associated with a beam prediction capability of the UE, the capability report indicating a target beam prediction accuracy.

As shown in FIG. 15, the apparatus 1505 may include circuitry for receiving a request to perform a beam prediction task aligned with the capability report (circuitry 1530). For example, the circuitry 1530 may enable the apparatus 1505 to receive a request to perform a beam prediction task aligned with the capability report.

As shown in FIG. 15, the apparatus 1505 may include, stored in computer-readable medium 1425, code for receiving a request to perform a beam prediction task aligned with the capability report (code 1535). For example, the code 1535, when executed by processor 1420, may cause processor 1420 to cause transceiver 1430 to receive a request to perform a beam prediction task aligned with the capability report.

As shown in FIG. 15, the apparatus 1505 may include circuitry for transmitting, based at least in part on the request, a beam prediction result satisfying the target beam prediction accuracy indicated in the capability report (circuitry 1540). For example, the circuitry 1540 may enable the apparatus 1505 to transmit, based at least in part on the request, a beam prediction result satisfying the target beam prediction accuracy indicated in the capability report.

As shown in FIG. 15, the apparatus 1505 may include, stored in computer-readable medium 1425, code for transmitting, based at least in part on the request, a beam prediction result satisfying the target beam prediction accuracy indicated in the capability report (code 1545). For example, the code 1545, when executed by processor 1420, may cause processor 1420 to cause transceiver 1430 to transmit, based at least in part on the request, a beam prediction result satisfying the target beam prediction accuracy indicated in the capability report.

FIG. 15 is provided as an example. Other examples may differ from what is described in connection with FIG. 15.

FIG. 16 is a diagram of an example apparatus 1600 for wireless communication, in accordance with the present disclosure. The apparatus 1600 may be a network node, or a network node may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604.

In some aspects, the apparatus 1600 may be configured to perform one or more operations described herein in connection with FIGS. 7, 8A, 8B, 9A, 9B, 9C, and 10. Additionally, or alternatively, the apparatus 1600 may be configured to perform one or more processes described herein, such as process 1200 of FIG. 12. In some aspects, the apparatus 1600 and/or one or more components shown in FIG. 16 may include one or more components of the network node described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the network node described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the network node described in connection with FIG. 2. In some aspects, the transmission component 1604 may be co-located with the reception component 1602 in a transceiver.

The reception component 1602 may receive a capability report associated with a beam prediction capability of the UE, the capability report indicating a target beam prediction accuracy. The transmission component 1604 may transmit a request to perform a beam prediction task aligned with the capability report. The reception component 1602 may receive, based at least in part on the request, a beam prediction result satisfying the target beam prediction accuracy indicated in the capability report. The reception component 1602 may receive, after an initial access, an updated capability report indicating an updated beam prediction capability of the UE, wherein the capability report is associated with a first combination of UE capabilities and the updated capability report is associated with a second combination of UE capabilities.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

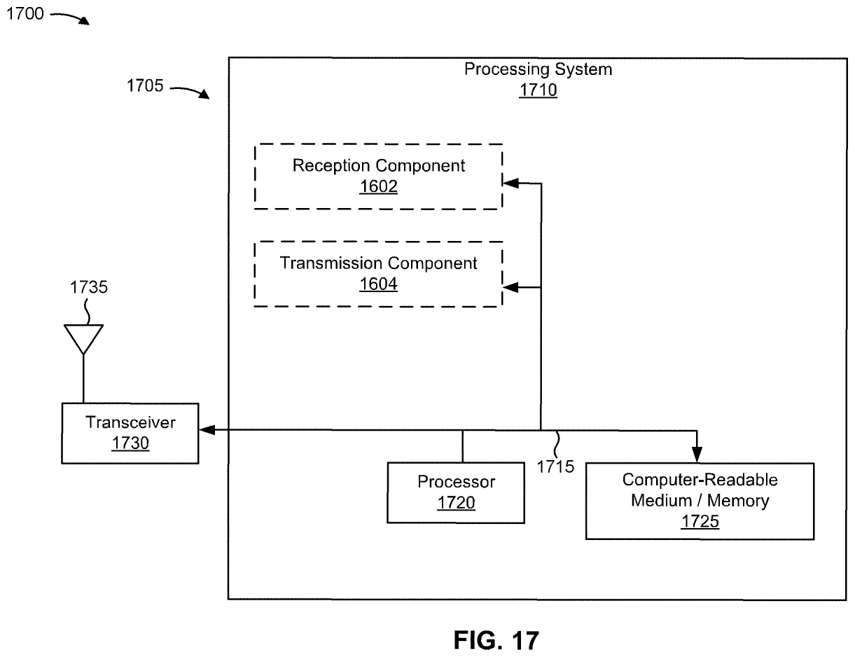

FIG. 17 is a diagram illustrating an example 1700 of a hardware implementation for an apparatus 1705 employing a processing system 1710, in accordance with the present disclosure. The apparatus 1705 may be a network node.

The processing system 1710 may be implemented with a bus architecture, represented generally by the bus 1715. The bus 1715 may include any number of interconnecting buses and bridges depending on the specific application of the processing system 1710 and the overall design constraints. The bus 1715 links together various circuits including one or more processors and/or hardware components, represented by the processor 1720, the illustrated components, and the computer-readable medium/memory 1725. The bus 1715 may also link various other circuits, such as timing sources, peripherals, voltage regulators, and/or power management circuits.

The processing system 1710 may be coupled to a transceiver 1730. The transceiver 1730 is coupled to one or more antennas 1735. The transceiver 1730 provides a means for communicating with various other apparatuses over a transmission medium. The transceiver 1730 receives a signal from the one or more antennas 1735, extracts information from the received signal, and provides the extracted information to the processing system 1710, specifically the reception component 1602. In addition, the transceiver 1730 receives information from the processing system 1710, specifically the transmission component 1604, and generates a signal to be applied to the one or more antennas 1735 based at least in part on the received information.

The processing system 1710 includes a processor 1720 coupled to a computer-readable medium/memory 1725. The processor 1720 is responsible for general processing, including the execution of software stored on the computer-readable medium/memory 1725. The software, when executed by the processor 1720, causes the processing system 1710 to perform the various functions described herein for any particular apparatus. The computer-readable medium/memory 1725 may also be used for storing data that is manipulated by the processor 1720 when executing software. The processing system further includes at least one of the illustrated components. The components may be software modules running in the processor 1720, resident/stored in the computer readable medium/memory 1725, one or more hardware modules coupled to the processor 1720, or some combination thereof.

In some aspects, the processing system 1710 may be a component of the base station 110 and may include the memory 242 and/or at least one of the TX MIMO processor 230, the Rx processor 238, and/or the controller/processor 240. In some aspects, the apparatus 1705 for wireless communication includes means for receiving a capability report associated with a beam prediction capability of the UE, the capability report indicating a target beam prediction accuracy; means for transmitting a request to perform a beam prediction task that is aligned with the capability report; and means for receiving, based at least in part on the request, a beam prediction result satisfying the target beam prediction accuracy indicated in the capability report. The aforementioned means may be one or more of the aforementioned components of the apparatus 1600 and/or the processing system 1710 of the apparatus 1705 configured to perform the functions recited by the aforementioned means. As described elsewhere herein, the processing system 1710 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 17 is provided as an example. Other examples may differ from what is described in connection with FIG. 17.

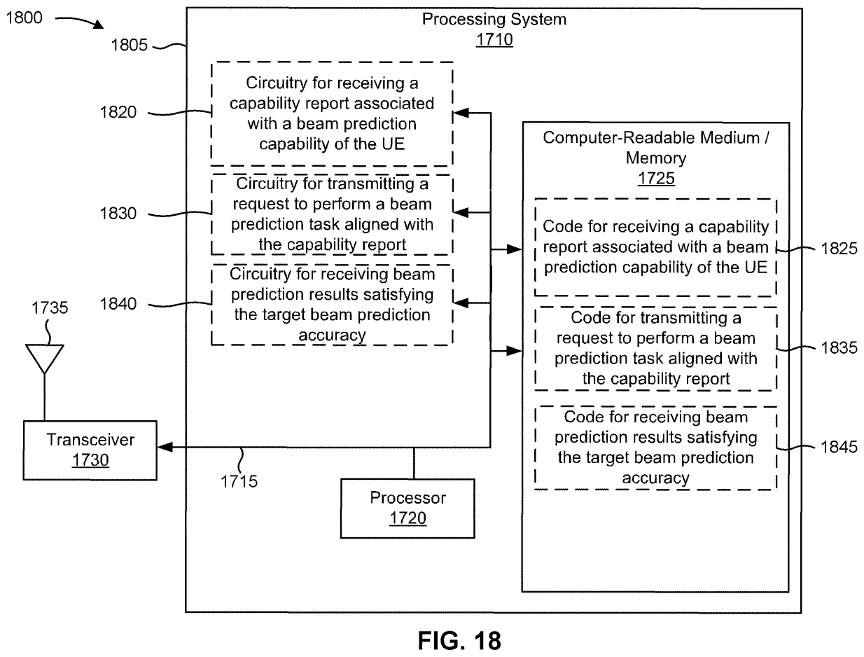

FIG. 18 is a diagram illustrating an example 1800 of an implementation of code and circuitry for an apparatus 1805, in accordance with the present disclosure. The apparatus 1805 may be a network node, or a network node may include the apparatus 1805.

As shown in FIG. 18, the apparatus 1805 may include circuitry for receiving a capability report associated with a beam prediction capability of the UE, the capability report indicating a target beam prediction accuracy (circuitry 1820). For example, the circuitry 1820 may enable the apparatus 1805 to receive a capability report associated with a beam prediction capability of the UE, the capability report indicating a target beam prediction accuracy.

As shown in FIG. 18, the apparatus 1805 may include, stored in computer-readable medium 1725, code for receiving a capability report associated with a beam prediction capability of the UE, the capability report indicating a target beam prediction accuracy (code 1825). For example, the code 1825, when executed by processor 1720, may cause processor 1720 to cause transceiver 1730 to receive a capability report associated with a beam prediction capability of the UE, the capability report indicating a target beam prediction accuracy.

As shown in FIG. 18, the apparatus 1805 may include circuitry for transmitting a request to perform a beam prediction task aligned with the capability report (circuitry 1830). For example, the circuitry 1830 may enable the apparatus 1805 to transmit a request to perform a beam prediction task aligned with the capability report.

As shown in FIG. 18, the apparatus 1805 may include, stored in computer-readable medium 1725, code for transmitting a request to perform a beam prediction task aligned with the capability report (code 1835). For example, the code 1835, when executed by processor 1720, may cause processor 1720 to cause transceiver 1730 to transmit a request to perform a beam prediction task aligned with the capability report.

As shown in FIG. 18, the apparatus 1805 may include circuitry for receiving, based at least in part on the request, a beam prediction result satisfying the target beam prediction accuracy indicated in the capability report (circuitry 1840). For example, the circuitry 1840 may enable the apparatus 1805 to receive, based at least in part on the request, a beam prediction result satisfying the target beam prediction accuracy indicated in the capability report.

As shown in FIG. 18, the apparatus 1805 may include, stored in computer-readable medium 1725, code for receiving, based at least in part on the request, a beam prediction result satisfying the target beam prediction accuracy indicated in the capability report (code 1845). For example, the code 1845, when executed by processor 1720, may cause processor 1720 to cause transceiver 1730 to receive, based at least in part on the request, a beam prediction result satisfying the target beam prediction accuracy indicated in the capability report.

FIG. 18 is provided as an example. Other examples may differ from what is described in connection with FIG. 18.

The following provides an overview of some Aspects of the present disclosure:

Aspect 1: A method of wireless communication performed at an apparatus of a user equipment (UE), comprising: transmitting a capability report associated with a beam prediction capability of the UE, the capability report indicating a target beam prediction accuracy; receiving a request to perform a beam prediction task aligned with the capability report; and transmitting, based at least in part on the request, a beam prediction result satisfying the target beam prediction accuracy indicated in the capability report.

Aspect 2: The method of Aspect 1, wherein the target beam prediction accuracy is associated with an average prediction error.

Aspect 3: The method of any of Aspects 1 through 2, wherein the target beam prediction accuracy is associated with a maximum prediction error.

Aspect 4: The method of any of Aspects 1 through 3, wherein the target beam prediction accuracy is associated with a standard predefined prediction error.

Aspect 5: The method of any of Aspects 1 through 4, wherein an average prediction error, a maximum prediction error, or a standard predefined prediction error is based at least in part on reporting a single value across a plurality of beams associated with prediction target beams.

Aspect 6: The method of any of Aspects 1 through 5, wherein an average prediction error, a maximum prediction error, or a standard predefined prediction error is based at least in part on reporting multiple values for the plurality of beams associated with the prediction target beams.

Aspect 7: The method of any of Aspects 1 through 6, wherein an average prediction error is associated with one or more of: a layer 1 reference signal received power, a layer 1 signal-to-interference-plus-noise ratio, a rank indicator, or a channel quality indicator.

Aspect 8: The method of any of Aspects 1 through 7, wherein a maximum prediction error is associated with one or more of: a layer 1 reference signal received power, a layer 1 signal-to-interference-plus-noise ratio, a rank indicator, or a channel quality indicator.

Aspect 9: The method of any of Aspects 1 through 8, wherein a standard predefined prediction error is associated with one or more of: a layer 1 reference signal received power, a layer 1 signal-to-interference-plus-noise ratio, a rank indicator, or a channel quality indicator.

Aspect 10: The method of any of Aspects 1 through 9, wherein the capability report indicates a quantity of reference signal resources indicated as measurement resources for beam prediction.

Aspect 11: The method of any of Aspects 1 through 10, wherein the capability report indicates types of reference signal resources indicated as measurement resources for beam prediction.

Aspect 12: The method of any of Aspects 1 through 11, wherein types of reference signal resources indicated as measurement resources for beam prediction are associated with reference signal resources with a certain periodicity.

Aspect 13: The method of any of Aspects 1 through 12, wherein types of reference signal resources indicated as measurement resources for beam prediction are associated with reference signal resources with a single port.

Aspect 14: The method of any of Aspects 1 through 13, wherein types of reference signal resources indicated as measurement resources for beam prediction are associated with reference signal resources with multiple ports.

Aspect 15: The method of any of Aspects 1 through 14, wherein the capability report indicates a quantity of historical time domain measurement occasions used as inputs for beam prediction.

Aspect 16: The method of any of Aspects 1 through 15, wherein the capability report indicates an interval between adjacent historical time domain occasions used as inputs for beam prediction.

Aspect 17: The method of any of Aspects 1 through 16, wherein the capability report indicates a quantity of beams as prediction target beams.

Aspect 18: The method of any of Aspects 1 through 17, wherein the capability report indicates types of beams as prediction target beams.

Aspect 19: The method of any of Aspects 1 through 18, wherein types of beams as prediction target beams are associated with beams that carry reference signal resources configured as measurement resources.

Aspect 20: The method of any of Aspects 1 through 19, wherein types of beams as prediction target beams are associated with beams that do not carry reference signal resources configured as measurement resources.

Aspect 21: The method of any of Aspects 1 through 20, wherein types of beams as prediction target beams are associated with beams that are periodically transmitted.

Aspect 22: The method of any of Aspects 1 through 21, wherein types of beams as prediction target beams are associated with beams that are not periodically transmitted.

Aspect 23: The method of any of Aspects 1 through 22, wherein the capability report indicates a quantity of upcoming time domain occasions predicted for beams as prediction target beams.

Aspect 24: The method of any of Aspects 1 through 23, wherein the capability report indicates an interval between adjacent upcoming time domain occasions predicted for beams as prediction target beams.

Aspect 25: The method of any of Aspects 1 through 24, wherein transmitting the capability report comprises transmitting the capability report via radio resource control signaling during an initial access.

Aspect 26: The method of any of Aspects 1 through 25, wherein the capability report indicates one or more combinations of UE capabilities comprising: a target beam prediction accuracy, one or more of a quantity of reference signal resources indicated as measurement resources or types of reference signal resources indicated as measurement resources, and one or more of a quantity of beams as prediction target beams or types of beams as prediction target beams.

Aspect 27: The method of any of Aspects 1 through 26, wherein the capability report indicates one or more combinations of UE capabilities based at least in part on a standard predefinition or a pre-configuration.

Aspect 28: The method of any of Aspects 1 through 27, wherein the capability report indicates one or more sets of combinations of UE capabilities.

Aspect 29: The method of any of Aspects 1 through 28, wherein a set of combinations of UE capabilities from one or more sets of combinations of UE capabilities indicates one or more combinations of UE capabilities.

Aspect 30: The method of any of Aspects 1 through 29, wherein a set of combinations of UE capabilities are configured to be simultaneously activated for the UE.

Aspect 31: The method of any of Aspects 1 through 30, further comprising: transmitting, after an initial access, an updated capability report indicating an updated beam prediction capability of the UE.

Aspect 32: The method of any of Aspects 1 through 31, wherein the capability report is associated with a first combination of UE capabilities and an updated capability report is associated with a second combination of UE capabilities.

Aspect 33: A method of wireless communication performed at an apparatus of a network node, comprising: receiving a capability report associated with a beam prediction capability of a user equipment (UE), the capability report indicating a target beam prediction accuracy, transmitting a request to perform a beam prediction task aligned with the capability report, and receiving, based at least in part on the request, a beam prediction result satisfying the target beam prediction accuracy indicated in the capability report.

Aspect 34: The method of Aspect 33, wherein the target beam prediction accuracy is associated with an average prediction error.

Aspect 35: The method of any of Aspects 33 through 34, wherein the target beam prediction accuracy is associated with a maximum prediction error.

Aspect 36: The method of any of Aspects 33 through 35, wherein the target beam prediction accuracy is associated with a standard predefined prediction error.

Aspect 37: The method of any of Aspects 33 through 36, wherein an average prediction error, a maximum prediction error, or a standard predefined prediction error is based at least in part on reporting a single value across a plurality of beams associated with prediction target beams.

Aspect 38: The method of any of Aspects 33 through 37, wherein an average prediction error, a maximum prediction error, or a standard predefined prediction error is based at least in part on reporting multiple values for the plurality of beams associated with the prediction target beams.

Aspect 39: The method of any of Aspects 33 through 38, wherein an average prediction error is associated with one or more of: a layer 1 reference signal received power, a layer 1 signal-to-interference-plus-noise ratio, a rank indicator, or a channel quality indicator.

Aspect 40: The method of any of Aspects 33 through 39, wherein a maximum prediction error is associated with one or more of: a layer 1 reference signal received power, a layer 1 signal-to-interference-plus-noise ratio, a rank indicator, or a channel quality indicator.

Aspect 41: The method of any of Aspects 33 through 40, wherein a standard predefined prediction error is associated with one or more of: a layer 1 reference signal received power, a layer 1 signal-to-interference-plus-noise ratio, a rank indicator, or a channel quality indicator.

Aspect 42: The method of any of Aspects 33 through 41, wherein the capability report indicates a quantity of reference signal resources indicated as measurement resources for beam prediction.

Aspect 43: The method of any of Aspects 33 through 42, wherein the capability report indicates types of reference signal resources indicated as measurement resources for beam prediction.

Aspect 44: The method of any of Aspects 33 through 43, wherein types of reference signal resources indicated as measurement resources for beam prediction are associated with reference signal resources with a certain periodicity.

Aspect 45: The method of any of Aspects 33 through 44, wherein types of reference signal resources indicated as measurement resources for beam prediction are associated with reference signal resources with a single port.

Aspect 46: The method of any of Aspects 33 through 45, wherein types of reference signal resources indicated as measurement resources for beam prediction are associated with reference signal resources with multiple ports.

Aspect 47: The method of any of Aspects 33 through 46, wherein the capability report indicates a quantity of historical time domain measurement occasions used as inputs for beam prediction.

Aspect 48: The method of any of Aspects 33 through 47, wherein the capability report indicates an interval between adjacent historical time domain occasions used as inputs for beam prediction.

Aspect 49: The method of any of Aspects 33 through 48, wherein the capability report indicates a quantity of beams as prediction target beams.

Aspect 50: The method of any of Aspects 33 through 49, wherein the capability report indicates types of beams as prediction target beams.

Aspect 51: The method of any of Aspects 33 through 50, wherein types of beams as prediction target beams are associated with beams that carry reference signal resources configured as measurement resources.

Aspect 52: The method of any of Aspects 33 through 51, wherein types of beams as prediction target beams are associated with beams that do not carry reference signal resources configured as measurement resources.

Aspect 53: The method of any of Aspects 33 through 52, wherein types of beams as prediction target beams are associated with beams that are periodically transmitted.

Aspect 54: The method of any of Aspects 33 through 53, wherein types of beams as prediction target beams are associated with beams that are not periodically transmitted.

Aspect 55: The method of any of Aspects 33 through 54, wherein the capability report indicates a quantity of upcoming time domain occasions predicted for beams as prediction target beams.

Aspect 56: The method of any of Aspects 33 through 55, wherein the capability report indicates an interval between adjacent upcoming time domain occasions predicted for beams as prediction target beams.

Aspect 57: The method of any of Aspects 33 through 56, wherein receiving the capability report comprises receiving the capability report via radio resource control signaling during an initial access.

Aspect 58: The method of any of Aspects 33 through 57, wherein the capability report indicates one or more combinations of UE capabilities comprising: a target beam prediction accuracy, one or more of a quantity of reference signal resources indicated as measurement resources or types of reference signal resources indicated as measurement resources, and one or more of a quantity of beams as prediction target beams or types of beams as prediction target beams.

Aspect 59: The method of any of Aspects 33 through 58, wherein the capability report indicates one or more combinations of UE capabilities based at least in part on a standard predefinition or a pre-configuration.

Aspect 60: The method of any of Aspects 33 through 59, wherein the capability report indicates one or more sets of combinations of UE capabilities.

Aspect 61: The method of any of Aspects 33 through 60, wherein a set of combinations of UE capabilities from one or more sets of combinations of UE capabilities indicates one or more combinations of UE capabilities.

Aspect 62: The method of any of Aspects 33 through 61, wherein a set of combinations of UE capabilities are configured to be simultaneously activated for the UE.

Aspect 63: The method of any of Aspects 33 through 62, further comprising: receiving, after an initial access, an updated capability report indicating an updated beam prediction capability of the UE.

Aspect 64: The method of any of Aspects 33 through 63, wherein the capability report is associated with a first combination of UE capabilities and an updated capability report is associated with a second combination of UE capabilities.

Aspect 65: An apparatus for wireless communication at a device, comprising a processor; memory coupled with the processor; and instructions stored in the memory and executable by the processor to cause the apparatus to perform the method of one or more of Aspects 1-32.

Aspect 66: A device for wireless communication, comprising a memory and one or more processors coupled to the memory, the one or more processors configured to perform the method of one or more of Aspects 1-32.

Aspect 67: An apparatus for wireless communication, comprising at least one means for performing the method of one or more of Aspects 1-32.

Aspect 68: A non-transitory computer-readable medium storing code for wireless communication, the code comprising instructions executable by a processor to perform the method of one or more of Aspects 1-32.

Aspect 69: A non-transitory computer-readable medium storing a set of instructions for wireless communication, the set of instructions comprising one or more instructions that, when executed by one or more processors of a device, cause the device to perform the method of one or more of Aspects 1-32.

Aspect 70: An apparatus for wireless communication at a device, comprising a processor; memory coupled with the processor; and instructions stored in the memory and executable by the processor to cause the apparatus to perform the method of one or more of Aspects 33-64.

Aspect 71: A device for wireless communication, comprising a memory and one or more processors coupled to the memory, the one or more processors configured to perform the method of one or more of Aspects 33-64.

Aspect 72: An apparatus for wireless communication, comprising at least one means for performing the method of one or more of Aspects 33-64.

Aspect 73: A non-transitory computer-readable medium storing code for wireless communication, the code comprising instructions executable by a processor to perform the method of one or more of Aspects 33-64.

Aspect 74: A non-transitory computer-readable medium storing a set of instructions for wireless communication, the set of instructions comprising one or more instructions that, when executed by one or more processors of a device, cause the device to perform the method of one or more of Aspects 33-64.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, andc+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
a memory; and
one or more processors, coupled to the memory, configured to:
transmit a capability report associated with a beam prediction capability of the UE, the capability report indicating a target beam prediction accuracy;
receive a request to perform a beam prediction task based on the capability report; and
transmit, based at least in part on the request, a beam prediction result satisfying the target beam prediction accuracy indicated in the capability report.

2. The apparatus of claim 1, wherein the target beam prediction accuracy is associated with one or more of:
an average prediction error,
a maximum prediction error, or
a standard predefined prediction error,
wherein the average prediction error, the maximum prediction error, or the standard predefined prediction error is based at least in part on reporting a single value across a plurality of beams associated with prediction target beams, or is based at least in part on reporting multiple values for the plurality of beams associated with the prediction target beams.

3. The apparatus of claim 2, wherein the average prediction error, the maximum prediction error, and the standard predefined prediction error are each associated with one or more of:
a layer 1 reference signal received power,
a layer 1 signal-to-interference-plus-noise ratio,
a rank indicator, or
a channel quality indicator.

4. The apparatus of claim 1, wherein the capability report indicates one or more of:
a quantity of reference signal resources indicated as measurement resources for beam prediction, or
types of reference signal resources indicated as measurement resources for beam prediction.

5. The apparatus of claim 4, wherein the types of reference signal resources indicated as measurement resources for beam prediction are associated with one or more of:
reference signal resources with a certain periodicity,
reference signal resources with a single port, or
reference signal resources with multiple ports.

6. The apparatus of claim 4, wherein the capability report indicates one or more of:
a quantity of historical time domain measurement occasions used as inputs for the beam prediction, or
an interval between adjacent historical time domain occasions used as inputs for the beam prediction.

7. The apparatus of claim 1, wherein the capability report indicates one or more of:
a quantity of beams as prediction target beams, or
types of beams as prediction target beams.

8. The apparatus of claim 7, wherein the types of beams indicated as prediction target beams are associated with one or more of:
beams that carry reference signal resources configured as measurement resources,
beams that do not carry reference signal resources configured as measurement resources,
beams that are periodically transmitted, or
beams that are not periodically transmitted.

9. The apparatus of claim 7, wherein the capability report indicates one or more of:
a quantity of upcoming time domain occasions predicted for beams as the prediction target beams, or
an interval between adjacent upcoming time domain occasions predicted for the beams as the prediction target beams.

10. The apparatus of claim 1, wherein the one or more processors, to transmit the capability report, are configured to transmit the capability report via radio resource control signaling during an initial access.

11. The apparatus of claim 1, wherein the capability report indicates one or more combinations of UE capabilities comprising:
a target beam prediction accuracy,
one or more of a quantity of reference signal resources indicated as measurement resources or types of reference signal resources indicated as measurement resources, and
one or more of a quantity of beams indicated as prediction target beams or types of beams as prediction target beams,
wherein the capability report indicates the one or more combinations of UE capabilities based at least in part on a standard predefinition or a pre-configuration.

12. The apparatus of claim 11, wherein the capability report indicates one or more sets of combinations of UE capabilities, wherein a set of combinations of UE capabilities from the one or more sets of combinations of UE capabilities indicates the one or more combinations of UE capabilities, and wherein the set of combinations of UE capabilities are configured to be simultaneously activated for the UE.

13. The apparatus of claim 1, wherein the one or more processors are further configured to:
transmit, after an initial access, an updated capability report indicating an updated beam prediction capability of the UE, wherein the capability report is associated with a first combination of UE capabilities and the updated capability report is associated with a second combination of UE capabilities.

14. An apparatus for wireless communication at a network node, comprising:
a memory; and
one or more processors, coupled to the memory, configured to:
receive a capability report associated with a beam prediction capability of a user equipment (UE), the capability report indicating a target beam prediction accuracy;
transmit a request to perform a beam prediction task based on the capability report; and
receive, based at least in part on the request, a beam prediction result satisfying the target beam prediction accuracy indicated in the capability report.

15. The apparatus of claim 14, wherein the target beam prediction accuracy is associated with one or more of:
an average prediction error,
a maximum prediction error, or
a standard predefined prediction error,
wherein the average prediction error, the maximum prediction error, or the standard predefined prediction error is based at least in part on reporting a single value across a plurality of beams associated with prediction target beams, or is based at least in part on reporting multiple values for the plurality of beams associated with the prediction target beams.

16. The apparatus of claim 15, wherein the average prediction error, the maximum prediction error, and the standard predefined prediction error are each associated with one or more of:
a layer 1 reference signal received power,
a layer 1 signal-to-interference-plus-noise ratio,
a rank indicator, or
a channel quality indicator.

17. The apparatus of claim 14, wherein the capability report indicates one or more of:
a quantity of reference signal resources indicated as measurement resources for beam prediction, or
types of reference signal resources indicated as measurement resources for beam prediction.

18-19. (canceled)

20. The apparatus of claim 14, wherein the capability report indicates one or more of:
a quantity of beams as prediction target beams, or
types of beams as prediction target beams.

21-22. (canceled)

23. The apparatus of claim 14, wherein the one or more processors, to receive the capability report, are configured to receive the capability report via radio resource control signaling during an initial access.

24. The apparatus of claim 14, wherein the capability report indicates one or more combinations of UE capabilities comprising:
a target beam prediction accuracy,
one or more of a quantity of reference signal resources indicated as measurement resources or types of reference signal resources indicated as measurement resources, and
one or more of a quantity of beams as prediction target beams or types of beams as prediction target beams,
wherein the capability report indicates the one or more combinations of UE capabilities based at least in part on a standard predefinition or a pre-configuration.

25-30. (canceled)
